(19) United States
(12) Patent Application Publication
(10) Pub. No.: US 2025/0170799 A1
(43) Pub. Date: May 29, 2025

(54) MULTILAYER FABRIC FOR CHEMICAL, BIOLOGICAL, RADIOLOGICAL, NUCLEAR, OR EXPLOSIVES PROTECTION

(71) Applicant: UIF (University Industry Foundation), Yonsei University, Seoul (KR)

(72) Inventors: Jin Kee HONG, Seoul (KR); You Na KIM, Seoul (KR)

(73) Assignee: UIF (University Industry Foundation), Yonsei University, Seoul (KR)

(21) Appl. No.: 18/956,795

(22) Filed: Nov. 22, 2024

(30) Foreign Application Priority Data
Nov. 23, 2023 (KR) 10-2023-0164443
Nov. 23, 2023 (KR) 10-2023-0164445
Nov. 23, 2023 (KR) 10-2023-0164446

(51) Int. Cl. B32B 5/26; A41D 13/00; B32B 3/28; B32B 5/02; B32B 5/08; B32B 7/02; B32B 7/14

(52) U.S. Cl. CPC B32B 5/265; A41D 13/0002; B32B 3/28; B32B 5/022; B32B 5/08; B32B 7/02; B32B 7/14; B32B 2255/02; B32B 2255/26; B32B 2262/0261; B32B 2262/0284; B32B 2262/106; B32B 2307/30; B32B 2307/56; B32B 2307/718; B32B 2307/7242; B32B 2307/7265; B32B 2437/00

(57) ABSTRACT

The present disclosure relates to a multilayer fabric for chemical, biological, radiological, nuclear or explosive protection of various structures. According to the present disclosure, durability and all-weather protective performance against chemical, biological and radiological weapons are improved, and superior comfort of wearing is provided. In addition, since heat and sweat can be discharged to the outside during the wearer's activities, it reduces thermal fatigue and provides excellent comfort and activity. In addition, it can be used in various ways not only for chemical, biological, and radiological protection but also as a protective product for private industries by increasing the protective performance against aerosol particles and vapor phase chemical reactions while maintaining the function of the inner fiber.

### BACKGROUND

### 1. Field

The present disclosure relates to a multilayer fabric for chemical, biological, radiological, nuclear or explosive protection capable of protecting a wearer from various types of chemical, biological and radiological weapons in battlefields and terrorism situations.

### 2. Description of the Related Art

A clothing for chemical, biological, radiological, nuclear or explosive protection is personal protective equipment that protects combat personnel from various types of chemical, biological and radiological weapons in battlefields and in terrorism situations. Chemical, biological, radiological and biological weapons refer to weapons of mass destruction used in war, terrorism, etc. In chemical, biological or radiological warfare situations, the attack is generally in the form of a liquid or a gas (vapor) for chemical agents, and aerosol-type particles for biological agents.

The materials for chemical, biological, radiological, nuclear or explosive protection are largely classified into impermeable, permeable, semi-permeable, and selectively permeable materials depending on whether they allow water vapor or air to escape. The impermeable materials block all types of contaminants that may enter from the outside. However, they are not suitable for urgent situations because they have the problem of reduced mission performance due to rapid increase of thermal fatigue after wearing.

The permeable/semi-permeable materials have emerged to improve mission performance by blocking contaminants and improving comfort of wearing. They are in the form of a fabric consisting of an outer layer and an inner layer. The inner layer is made of a layered structure of a support fabric, activated carbon and a cover fabric to protect the skin.

However, the permeable/semi-permeable materials have limitations in that they cannot completely block aerosol-type agents, can be used only for the period during which the adsorption of activated carbon is maintained, and have disadvantages in terms of convenience because they are heavy and do not discharge sweat.

Therefore, there is a need to develop multipurpose protective clothing materials that can protect the human body from chemical, biological, and radiological threats as well as radiation and explosions, while also reducing weight and increasing flexibility, increasing thermal comfort by reducing thermal fatigue, and improving activities.

### PATENT DOCUMENTS

Patent document 1. Korean Patent Registration No. 10-2586161.
Patent document 1. Korean Patent Publication No. 10-2020-0060985.

### SUMMARY

The present disclosure is directed to providing a multilayer fabric for chemical, biological, radiological, nuclear or explosive protection having a pressure gradient structure.

The present disclosure is also directed to providing a multilayer fabric for chemical, biological, radiological and explosive protection.

The present disclosure is also directed to providing a clothing for chemical, biological, radiological, nuclear or explosive protective, which includes the multilayer fabric.

The present disclosure provides a multilayer fabric for chemical, biological, radiological, nuclear or explosive protection having a multilayer pressure gradient structure, consisting of: a first aerosol blocking layer made of a nonwoven fabric composed of a thermoplastic polymer fiber having aerosol particle blocking property; an adsorption layer including an activated carbon fiber adsorbing an external chemical toxic substance attached to one surface of the first aerosol blocking layer; and a second aerosol blocking layer made of a nonwoven fabric composed of a thermoplastic polymer fiber having aerosol particle blocking property, the second aerosol blocking layer being attached to the other surface of the adsorption layer and having a basis weight that is 0.5 to 0.8 times lower than that of the first aerosol blocking layer.

The first aerosol blocking layer may be a nonwoven fabric prepared using one or more thermoplastic polymer fiber selected from a group consisting of polyurethane (PU), polypropylene (PP), polyester, polyethylene (PE), polyethylene terephthalate (PET), nylon (nylon 6), and viscose rayon.

The first aerosol blocking layer may be a mixed nonwoven fabric prepared from polyethylene terephthalate (PET) and nylon (nylon 6).

The first aerosol blocking layer may be a mixed nonwoven fabric prepared from polyethylene terephthalate (PET) and nylon (nylon 6) at a weight ratio of 40:60 to 60:40, and the second aerosol blocking layer may be a mixed nonwoven fabric prepared from polyethylene terephthalate (PET) and nylon (nylon 6) at a weight ratio of 10:90 to 20:80.

The first aerosol blocking layer may have a basis weight of 34 to 40 g/m².

The first aerosol blocking layer may have a basis weight of 34 to 35 g/m², and the second aerosol blocking layer may have a basis weight of 24 to 25 g/m².

The outer surface of the first aerosol blocking layer may further include a cover fabric prepared from a waterproof and heat-dissipating material.

A support fabric may be further arranged on the outer surface of the outer surface of the second aerosol blocking layer.

The first aerosol blocking layer may be a nonwoven fabric having a basis weight of 34 to 35 g/m² wherein polyethylene terephthalate (PET) and nylon (nylon 6) are mixed at a weight ratio of 40:60 to 60:40, and the second aerosol blocking layer may be a nonwoven fabric having a basis weight of 24 to 25 g/m² wherein polyethylene terephthalate (PET) and nylon (nylon 6) are mixed at a weight ratio of 10:90 to 20:80. The nonwoven fabric of the first aerosol blocking layer may have a pore distribution with a pore volume having a diameter of 100 μm (dV/d (log D)) of 9-10 when macropores (75 nm-1100 μm) are analyzed by mercury porosimetry, and the nonwoven fabric of the second aerosol blocking layer may have a pore distribution with a pore volume having a diameter of 100 μm (dV/d (log D)) of 5-6 when macropores (75 nm-1100 μm) are analyzed by mercury porosimetry. A thermoplastic polyamide adhesive with a glass transition temperature of 40° C. to 80° C. may be applied on one surface in dot form with an amount of 8 to 10 g/m² to a dot density of 20 to 180 dots/cm².

The present disclosure also provides a multilayer fabric for chemical, biological, radiological, nuclear or explosive protection, which includes: a first aerosol blocking layer made of a woven, knitted or nonwoven fabric prepared from any one selected from thermoplastic polymers having aerosol particle blocking property as a raw material; an adsorption layer disposed under the first aerosol blocking layer and prepared from an activated carbon fiber that adsorbs external chemical toxic substances from outside; a shock-absorbing layer disposed under the adsorption layer and including a viscoelastomer that absorbs and disperses shock; and a radiation shielding layer disposed under the shock-absorbing layer and including tungsten or boron nanoparticles.

The thermoplastic polymer may be one or more selected from a group consisting of polyurethane (PU), polypropylene (PP), polyester, polyethylene (PE), polyethylene terephthalate (PET), nylon (nylon 6), and viscose rayon.

The first aerosol blocking layer may be a mixed nonwoven fabric prepared from polyethylene terephthalate (PET) and nylon (nylon 6).

In the first aerosol blocking layer, the adhesive may be applied in dot form on the surface that comes into contact with the adsorption layer.

The activated carbon fiber of the adsorption layer may have a basis weight of 200 g/m² to 300 g/m² and a specific surface area of 2000 g/m² to 20,000 g/m², and may contain 70% to 90% of micropores with a size of 0.2 nm to 2 nm based on the total pore volume.

The viscoelastomer may be one or more selected from a group consisting of polytetrafluoroethylene (PTFE), low-density polyethylene (LDPE), polyvinyl alcohol (PVA), polyvinyl chloride (PVC), and polyurethane (PU).

The viscoelastomer may contain i. a hydrophilic polymer having a functional group capable of hydrogen bonding; and ii. a deep eutectic solvent, wherein the mixing weight ratio of the hydrophilic polymer having a functional group capable of hydrogen bonding and the eutectic solvent is 0.5:1 to 1.5:1.

The deep eutectic solvent may be choline chloride and glycerin mixed at a molar ratio of 1:1.5 to 1:2.5.

The activated carbon fiber of the adsorption layer may be arranged in a continuous wrinkle structure ranging from a flat form to a wave form. The wrinkle structure may be a wrinkle structure having a round curve, a wrinkle structure having a square-shaped block, or an inclined wrinkle structure.

The inclined wrinkle structure of the adsorption layer may be an inclined wrinkle structure having an angle of 30-50° toward the line of sight in an opposing position.

The multilayer fabric for chemical, biological, radiological, nuclear or explosive protection may further include the second aerosol blocking layer made of a nonwoven fabric consisting of a thermoplastic polymer fiber having aerosol particle blocking property, which is disposed below the radiation shielding layer and has a basis weight 0.5 to 0.8 times lower than that of the first aerosol blocking layer.

The nonwoven fabric of the first aerosol blocking layer may have a basis weight of 34 to 40 g/m², and the second aerosol blocking layer may have a basis weight of 17 to 32 g/m².

The multilayer fabric for chemical, biological, radiological, nuclear or explosive protection may further include the cover fabric coated with a water-repellent and oil-repellent agent and placed on top of the first aerosol blocking layer; and the support fabric placed under the radiation shielding layer.

The present disclosure also provides a clothing for chemical, biological, radiological, nuclear or explosive protection prepared using the multilayer fabric.

The multilayer fabric for chemical, biological, radiological, nuclear or explosive protection according to the present disclosure, which has first and second aerosol blocking layers having different pore distributions on both sides of an adsorption layer, exhibits improved all-weather chemical, biological, and radiological protective performance without weight increase, and excellent comfort of wearing. It is not only highly durable but also ensures comfort due to good air permeability and fast drying, thus allowing efficient discharge of sweat and heat generated inside to outside, and also provides excellent activities through improved stretchability. In addition, it can be used in various ways not only for chemical, biological, and radiological protection but also as a protective product for private industries by increasing the protective performance against aerosol particles and vapor phase chemical reactions while maintaining the function of the inner fiber.

The multilayer fabric for chemical, biological, radiological, nuclear or explosive protection according to the present disclosure not only has a protective effect against chemical, biological, and radiological weapons, but also has a shielding effect against explosions and radiation, and also has excellent moisture permeability, air permeability, and water vapor resistance. In addition, since the weight increase is relatively low compared to these effects, it can effectively protect the wearer in chemical, biological, radiological, nuclear, and explosive (CBRNE) disaster situations without additional equipment, and can be worn not only under regular combat uniforms but also everyday clothes because it causes little restriction or interference during evacuation or activities.

That is, since the multilayer fabric according to the present disclosure has improved air permeability and drying ability, it can provide a comfortable environment and activity to the wearer.

### BRIEF DESCRIPTION OF THE DRAWINGS

FIG. 1 is an exploded perspective view showing a first embodiment of a multilayer fabric for chemical, biological, radiological, nuclear or explosive protection according to the present disclosure.

FIG. 2 is an exploded perspective view showing a second exemplary embodiment of a multilayer fabric for chemical, biological, radiological, nuclear or explosive protection according to the present disclosure.

FIG. 3 is a cross-sectional view showing a third exemplary embodiment of a multilayer fabric for chemical, biological, radiological, nuclear or explosive protection according to the present disclosure.

FIGS. 4A to 4C show cross-sectional views of a fourth exemplary embodiment of a multilayer fabric for chemical, biological, radiological and explosive protection according to the present disclosure.

FIGS. 5A to 5C show cross-sectional views of a fifth exemplary embodiment of a multilayer fabric for chemical, biological, radiological and explosive protection according to the present disclosure.

FIG. 6 is a cross-sectional view showing a sixth exemplary embodiment of a multilayer fabric for chemical, biological, radiological and explosive protection according to the present disclosure.

FIG. 7 shows a result of comparing the pore distribution of a nonwoven fabric of a first aerosol blocking layer (basis weight: 35 g/m²) with a nonwoven fabric of a second aerosol blocking layer (basis weight: 25 g/m²).

FIG. 8 shows a result of comparing the pore distribution of a multilayer fabric for chemical, biological, radiological, nuclear or explosive protection prepared in Example 1 with an activated carbon fiber.

FIG. 9 shows the micropore distribution of a multilayer fabric for chemical, biological, radiological, nuclear or explosive protection and activated carbon fiber prepared in Example 1 and an activated carbon fiber.

FIG. 10 shows a result of analyzing the chemical agent simulant permeability of an activated carbon fiber, a multilayer fabric for chemical, biological, radiological, nuclear or explosive protection prepared in Example 1, and a multilayer fabric for chemical, biological, radiological, nuclear or explosive protection prepared in Comparative Example 1.

FIG. 11 shows a result of analyzing the air permeability of a multilayer fabric for chemical, biological, radiological, nuclear or explosive protection prepared in Example 1 and a multilayer fabric for chemical, biological, radiological, nuclear or explosive protection prepared in Comparative Example 1.

FIG. 12 shows a result of analyzing the moisture permeability of a multilayer fabric for chemical, biological, radiological, nuclear or explosive protection prepared in Example 1, a multilayer fabric for chemical, biological, radiological, nuclear or explosive protection prepared in Comparative Example 1, and an activated carbon fiber.

FIG. 13 shows the X-ray diffraction (XRD) spectra of a PVA aqueous solution prepared in Preparation Example 2 (before addition of DES) and a viscoelastomer prepared in Example 2 (after addition of DES).

FIG. 14 shows a result of measuring the tensile strength of a PVA aqueous solution prepared in Preparation Example 2 (before addition of DES) and a viscoelastomer prepared in Example 2 (after addition of DES).

FIG. 15 shows the Raman spectra obtained to confirm the bonding between polymer chains in a viscoelastomer prepared in Example 2 (after addition of DES) after treating with a chemical agent simulant (MeS).

FIG. 16 shows the X-ray diffraction (XRD) spectra of a viscoelastomer prepared in Example 2 before and after treatment with a chemical agent simulant (MeS) for 60 minutes.

FIG. 17 shows a result of measuring the viscoelastic coefficient (G′, G″) of a viscoelastomer prepared in Example 2 before and after treatment with a chemical agent simulant (MeS) for 60 minutes.

FIG. 18 shows a result of measuring the shear stress of a viscoelastomer prepared in Example 2 before and after treatment with a chemical agent simulant (MeS) for 60 minutes.

FIG. 19 shows a result of measuring the stress of a viscoelastomer prepared in Example 2 before and after treatment with a chemical agent simulant (MeS) for 60 minutes.

FIGS. 20A and 20B show a result of a LAOS (large-amplitude oscillatory shear) test for a viscoelastomer according to Example 2 before and after treatment with a chemical agent simulant (MeS). FIG. 20A shows shear stress depending on time, and FIG. 20B shows energy change depending on cycles.

### DETAILED DESCRIPTION

Hereinafter, a multilayer fabric for chemical, biological, radiological, nuclear or explosive protection according to exemplary embodiments or examples of the present disclosure will be described with reference to the attached drawings.

An aspect of the present disclosure will be described specifically with reference to examples and drawings regarding a multilayer fabric for chemical, biological, radiological, nuclear or explosive protection of the present disclosure having a pressure gradient structure that minimizes protective performance and thermal fatigue. However, the present disclosure is not limited to these exemplary embodiments and drawings.

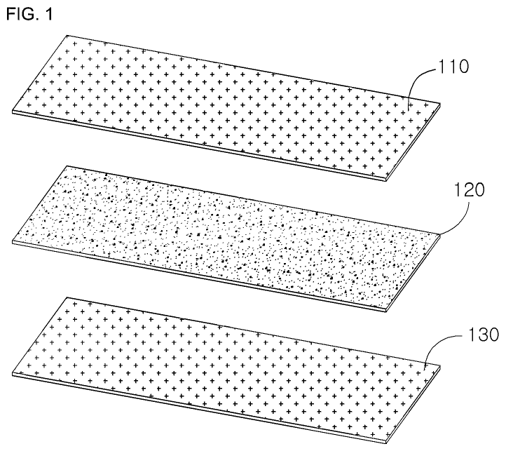

The multilayer fabric for chemical, biological, radiological, nuclear or explosive protection according to a first exemplary embodiment of the present disclosure includes a first aerosol blocking layer 110, an adsorption layer 120, and a second aerosol blocking layer 130, as shown in FIG. 1.

Specifically, the multilayer fabric for chemical, biological, radiological, nuclear or explosive protection with improved protective performance may be composed of a first aerosol blocking layer 110 made of a nonwoven fabric composed of a thermoplastic polymer fiber; an adsorption layer 120 including an activated carbon fiber that adsorbs external chemical toxic substances attached to one surface of the first aerosol blocking layer 110; and a second aerosol blocking layer made of a nonwoven fabric composed of a thermoplastic polymer fiber having aerosol particle blocking property and having a basis weight that is 0.5 to 0.8 times lower than that of the first aerosol blocking layer 110. More specifically, it may be composed of a first aerosol blocking layer 110 made of a mixed nonwoven fabric of polyethylene terephthalate (PET) and nylon, which is made of a nonwoven fabric composed of a thermoplastic polymer fiber; an adsorption layer 120 including an activated carbon fiber that adsorbs external chemical toxic substances attached to one side of the first aerosol blocking layer 110; and a second aerosol blocking layer 130 made of a nonwoven fabric composed of a thermoplastic polymer fiber attached to the other side of the adsorption layer and having a basis weight that is 0.5 to 0.8 times lower than that of the nonwoven fabric of the first aerosol blocking layer 110.

The multilayer fabric for chemical, biological, radiological, nuclear or explosive protection according to the present disclosure can provide protective performance not only against aerosol chemical agents but also against vapor or gaseous chemical agents by controlling the pore structure of the first and second aerosol blocking layers 110, 130 arranged on both sides of the adsorption layer 120, and has excellent air permeability, moisture permeability, water vapor resistance, and lightweightness. Therefore, the effect of improving the convenience and protective performance of a chemical, biological, and radiological protection clothing may be provided simultaneously. In addition, the multilayer fabric for chemical, biological, radiological, nuclear or explosive protection according to the present disclosure is highly commercializable because it does not require an additional processing process or preparation process for improvement of the characteristics described above.

In particular, the multilayer fabric for chemical, biological, radiological, nuclear or explosive protection according to the present disclosure not only improves the all-weather protective performance against aerosols as well as gaseous and vaporous chemical, biological, and radiological contaminants by controlling the pore structure of the first and second aerosol blocking layers without deforming the adsorption layer, but also has excellent air permeability and heat transfer characteristics due to high air permeability, moisture permeability, and water vapor resistance in addition to the improved protective performance without weight increase. Therefore, thermal fatigue due to activity does not accumulate but is regulated quickly, thereby maintaining a comfortable state.

The first aerosol blocking layer 110 can achieve an effect by having a nonwoven fabric pore structure different from that of the second aerosol blocking layer 120. The pore structure of the nonwoven fabric can be controlled with the basis weight of the nonwoven fabric. The basis weight of the nonwoven fabric can be adjusted with an electrospinning condition during the preparation of the nonwoven fabric or heating and pressurizing conditions during a densification process.

In the present disclosure, the first aerosol blocking layer 110 and the second aerosol blocking layer 120 can have a gradual or stepwise pore distribution in which the pore density increases in a direction from the wearer's skin toward the outside of the fabric. When the pore structure of the multilayer fabric for chemical, biological, radiological, nuclear or explosive protection is formed gradually, the efficiency of removing contaminants by the pore structure gradient may be insufficient, and the pores of the activated carbon fibers provided in the adsorption layer 120 may be excessively blocked. In addition, it is uneconomical compared to its efficiency due to an additional preparation process of the nonwoven fabric.

In order to improve the effect of removing chemical agents in the form of aerosols, liquids, gases and vapors while facilitating ventilation and discharge of sweat and heat by controlling the pore structure by the pressure gradient of the nonwoven fabric at the same time, it is preferable to arrange the first aerosol blocking layer 110 and the second aerosol blocking layer 130 having different pore structures on both sides of the adsorption layer 120.

The basis weight of the nonwoven fabric composed of a thermoplastic polymer fiber of the first aerosol blocking layer 110 may be determined based on the basis weight of the nonwoven fabric composed of a thermoplastic polymer fiber of the second aerosol blocking layer 120. Specifically, the second aerosol blocking layer 130 may be a nonwoven fabric composed of a thermoplastic polymer fiber having aerosol particle blocking property and having a basis weight that is 0.5 to 0.8 times lower than that of the nonwoven fabric composed of a thermoplastic polymer fiber of the first aerosol blocking layer 110.

More specifically, the nonwoven fabric of the first aerosol blocking layer 110 may have a basis weight of 34 to 40 g/m², and in this case, the second aerosol blocking layer 130 may use a nonwoven fabric having a basis weight of 10 to 32 g/m². Most specifically, the nonwoven fabric of the first aerosol blocking layer 110 may have a basis weight of 34 to 35 g/m², and the second aerosol blocking layer 130 may be a nonwoven fabric having a basis weight of 14 to 25 g/m².

When the nonwoven fabric of the first aerosol blocking layer 110 has a basis weight of 34 to 35 g/m² and the second aerosol blocking layer 130 has a basis weight of 14 to 25 g/m², the pore structure can be controlled finely to increase the adsorption rate and permeation resistance for vapor-type chemical agents without direct control of the activated carbon fiber used in the adsorption layer 120 while improving the circulation of air, moisture, and heat. Accordingly, when used as a product for chemical, biological, and radiological protection, it can reduce the wearer's thermal fatigue and increase activity by blocking the inflow of penetrating fluids, and at the same time actively discharging heat and moisture emitted from the wearer's body to the outside.

The difference in the pore distribution between the nonwoven fabric of the first aerosol blocking layer 110 and the nonwoven fabric of the second aerosol blocking layer 130 can be expressed as follows: upon analysis of macropores (75 nm-1100 μm) by mercury porosimetry, the volume of pores with a diameter of 100 μm (dV/d (log D)) may be, specifically, 9-10 for the nonwoven fabric of the first aerosol blocking layer (basis weight: 35 g/m²), and 5-6 for the nonwoven fabric of the second aerosol blocking layer (weight: 25 g/m²).

The multilayer fabric for chemical, biological, radiological, nuclear or explosive protection having the above-described composition blocks pores of 10 μm to 30 μm among the pores of the activated carbon fiber, but does not block pores of 50 μm or larger, which are important for air permeability. It also reduces micropores of smaller than 1 nm while maintaining micropores of 1-2 nm, and increases micropores of 7-10 nm.

That is, by precisely controlling and regulating the pore distribution of the activated carbon fiber, especially the type of micropores, with the pore gradient structure (pressure gradient structure) of the first and second aerosol blocking layers 110, 130, the protective performance and thermal fatigue-related moisture permeability, air permeability, and water vapor resistance can be improved without weight increase of the multilayer fabric for chemical, biological, radiological, nuclear or explosive protection.

The first aerosol blocking layer 110 is made of a nonwoven fabric composed of a thermoplastic polymer fiber having aerosol particle blocking property. It is located on the upper surface of the adsorption layer 120, and the first aerosol blocking layer 110 and the adsorption layer 120 are fixed by an adhesive.

The first aerosol blocking layer 110 is not particularly limited as long as it is a nonwoven fabric composed of a thermoplastic polymer fiber and has pores of 20 μm to 1000 μm. Specifically, it may be a nonwoven fabric prepared using one or more selected from a group consisting of polyurethane (PU), polypropylene (PP), polyester, polyethylene (PE), polyethylene terephthalate (PET), nylon (nylon 6), and viscose rayon. Most specifically, it may be a mixed nonwoven fabric prepared from polyethylene terephthalate (PET) and nylon (nylon 6).

In the present disclosure, the nonwoven fabric refers to a fabric in which the fibers contained have no longitudinal or transverse directionality, and the mixed nonwoven fabric refers to a nonwoven fabric formed by mixing two types of fibers obtained using different thermoplastic resins.

More specifically, the first aerosol blocking layer 110 may be a nonwoven fabric wherein polyethylene terephthalate and nylon fibers are mixed at a weight ratio of 40:60 to 60:40. If the weight ratio of the polyethylene terephthalate is lower than 40, tensile strength may decrease. And if it exceeds 60, the comfort of wearing may be poor due to rough texture and high tensile strength, and fuzzing may occur during washing.

When a mixed nonwoven fabric prepared from polyethylene terephthalate (PET) and nylon (nylon 6) is used as the first aerosol blocking layer 110, it not only provides protection against aerosols and blocking and removal of radioactive particles and viruses/biological agents, but also provides good air permeability and ensures comfort due to fast drying and efficient discharge of sweat and heat generated inside to the outside. In addition, it provides excellent activity by improving stretchability.

The nonwoven fabric is not particularly limited in its preparation process. Specifically, a dry nonwoven fabric such as a chemically bonded nonwoven fabric, a thermally bonded nonwoven fabric, an air-laid nonwoven fabric, etc., a wet nonwoven fabric, a spanless nonwoven fabric, a needle-punched nonwoven fabric, or a melt-blown nonwoven fabric can be used. More specifically, it can be obtained by electrospinning a polymer solution containing fibers, and the electrospinning may be specifically performed at a voltage of 5 to 20 V. The mixed nonwoven fabric prepared through the above process can be prepared into a sheet form through a pressing process.

Specifically, a step of densifying the mixed nonwoven fabric may be further included, and the densification may be performed by a belt press (BP) process or a calendering (CA) process. The belt press process is a process in which a nonwoven fabric is passed between two upper and lower heating belts, and the surface flatness of the nonwoven fabric is increased and a dense structure is provided by applying preset temperature and pressure. The calendering process is a process of heating and pressurizing a nonwoven fabric by passing it between two rotating heating rollers to make it denser.

Additionally, the first aerosol blocking layer 110 may be surface-treated to be water-repellent or oil-repellent so that it can be used for chemical, biological, radiological, nuclear or explosive protection. That is, the nonwoven fabric of the first aerosol blocking layer 110 may be treated to be water-repellent or oil-repellent.

An adhesive may be applied to one side of the first aerosol blocking layer 110, and the adsorption layer 120 may be arranged on the surface to which the adhesive is applied, so that the surface of the adsorption layer 120 is fixed by the adhesive of the first aerosol blocking layer 110. The surface on which the adsorption layer 120 is fixed is also called a ‘lower surface of the first aerosol blocking layer’ in the present disclosure.

The adhesive is not particularly limited as long as it is a thermoplastic adhesive that allows the activated carbon fiber of the adsorption layer 120 to be fixed firmly. Specifically, it may be one or more selected from a group consisting of polyethylene (HDPE, LDPE), polyamide (PA), polyurethane (PU), and polyester (PES). More specifically, a polyamide adhesive having a glass transition temperature of 40° C. to 80° C. may be used.

In addition, the adhesive may be applied on one surface to which the adsorption layer 120 of the first aerosol blocking layer 110 is fixed with an amount of 8 to 10 g/cm² to a dot density of 20 to 180 dots/cm² (dot form), and the dot-form adhesive may be firmly fixed to the first aerosol blocking layer 110 while minimizing decrease in the specific surface area of the adsorption layer 120. Through this, flexibility may be improved while maintaining the ventilation and protective functions of the fabric. If the adhesive is applied on the entire surface rather than in dot form, the first aerosol blocking layer and the adsorption layer are adhered completely without an air layer between them, leading to significant decrease of the specific surface area of the activated carbon fiber. In addition, the wearer's comfort of wearing may be unsatisfactory since the fabric becomes stiff. In other words, by minimizing only a portion of the adsorption layer 120 and fixing it to the first aerosol blocking layer 110, the decrease of specific surface area is prevented, and the comfort of wearing is improved. Accordingly, even when the multilayer fabric for chemical, biological, radiological, nuclear or explosive protection according to the present disclosure is designed to adhere to the wearer's entire body or only part of the body owing to the elasticity of the first aerosol blocking layer 110, work performance can be improved by preventing the accumulation of thermal fatigue since airtightness can be provided by effectively limiting the entry and exit of chemical agents into the body, while exhibiting sufficiently high air permeability, moisture permeability, and water vapor resistance, so that sweat and heat can be discharged quickly.

The first aerosol blocking layer 110 may be composed of a single layer or multiple layers. When it is prepared as multiple layers to provide rigidity to the multilayer fabric for chemical, biological, radiological, nuclear or explosive protection according to the present disclosure, the basis weight of the nonwoven fabrics of the layers should be the same. When the first aerosol blocking layer 110 is a single layer, the thickness may be 300 μm or smaller, specifically 100 to 300 μm, and more specifically 200 to 300 μm. When the first aerosol blocking layer 110 is multiple layers, protective power and rigidity increase as the number of layers increases. However, if the number of the layers is too large, the air permeability and moisture permeability of the entire chemical, biological, and radiological protection fabric may decrease, and activity may be restricted due to weight increase. Therefore, in order to increase protective power against aerosols while minimizing air permeability, moisture permeability, and weight increase, the first aerosol blocking layer 110 may be configured as a single layer or multiple layers depending on the intended use and desired effect.

The second aerosol blocking layer 130 is arranged on the other side of the adsorption layer 120, as illustrated in FIG. 1. The other side of the adsorption layer 120 means the side of the adsorption layer 120 which is opposite to the side of the adsorption layer 120 attached to the first aerosol blocking layer 110. For convenience, in the present disclosure, it can be referred to as the lower surface of the adsorption layer 120, and it corresponds to the upper surface of the second aerosol blocking layer 130.

The second aerosol blocking layer 130 is also not particularly limited as long as it is a nonwoven fabric having aerosol particle blocking property. It may be prepared from any one or more material selected from among the materials mentioned above in the description of the first aerosol blocking layer 110. However, as described above, it is preferred that the second aerosol blocking layer 130 is a nonwoven fabric composed of a thermoplastic polymer fiber having a basis weight 0.5 to 0.8 times lower than that of the first aerosol blocking layer.

The material of the second aerosol blocking layer 130 may be the same as or different from that of the first aerosol blocking layer 110. Specifically, the same material or a material with a different mixing ratio may be used. Specifically, the first aerosol blocking layer 110 may be a nonwoven fabric wherein polyethylene terephthalate (PET) and nylon (nylon 6) are mixed at a weight ratio of 40:60 to 60:40, the second aerosol blocking layer 130 may be a nonwoven fabric wherein polyethylene terephthalate (PET) and nylon (nylon 6) are mixed at a weight ratio of 10:90 to 20:80. In this case, the overall life characteristics of the fabric can be improved because a structure with superior physical properties can be provided. In addition, since the above-described configuration controls the wetness of the fabric from the skin to the outside without a support fabric or a cover fabric, thereby promoting moisture permeation, the fabric can effectively release moisture generated from the skin to the outside while being lightweight and prevented from becoming wet.

In addition, the second aerosol blocking layer 130 may contain an adhesive on the surface (‘upper surface’) to which the adsorption layer 120 is attached, similarly to the first aerosol blocking layer 110, so that the wrinkle structure of the activated carbon fiber is fixed to the second aerosol blocking layer 130.

It is preferred that the adsorption layer 120 is fixed not only to the first aerosol blocking layer 110 but also to the second aerosol blocking layer 130, so as to protect the wearer from penetration of sharp objects. If the second aerosol blocking layer 130 in contact with the wearer's skin is not fixed but is movable, the pore structure of the fabric may be deformed or twisted, causing the activated carbon fiber of the adsorption layer 120 to be torn easily, and the contamination of the adsorption layer may occur due to secretions from the skin.

The adsorption layer 120 is provided with an activated carbon fiber that adsorbs external chemical toxic substances. It is placed between the first aerosol blocking layer 110 and the second aerosol blocking layer 130 so that the activated carbon fiber is fixed within the fabric.

The adsorption layer 120 includes activated carbon fibers, which are attached and fixed between the first aerosol blocking layer 110 and the second aerosol blocking layer 130 by an adhesive dispersed in dot form so as to improve the surface area of the adsorption layer 120, which can improve the protective performance against contaminants (chemical agent liquids, vapors, aerosols, radioactive particles, and virus/biological agents), and also can minimize the reduction in specific surface area by minimizing the bonding area with the adhesive. In addition, due to the position between the controlled pore gradient structure of the first aerosol blocking layer 110 and the second aerosol blocking layer 130, the protective function can be maximized even with only a small amount of activated carbon fibers, while comfort can be ensured and superior stretchability and activity can be provided through quick drying and efficient discharge of sweat and heat generated inside to the outside.

For the chemical agents, since chemical agents spread in the form of particles (aerosol phase) or fog of about 0.001 to 1000 μm in size, and appear in the form of vapor after a certain period of time, it is desirable for the protective performance to work for both the aerosol and fog forms. However, conventional protective clothing is based on the principle of primary protection from the outer skin and secondary absorption from the inner skin, and has little consideration for the protective effect against gaseous chemical agents. In addition, it is difficult to achieve the effect of blocking chemical, biological, and radiological weapons while simultaneously allowing sweat and heat to escape from the human body.

On the other hand, the multilayer fabric for chemical, biological, radiological, nuclear or explosive protection according to the present disclosure provides a pressure gradient structure that induces pressure drop in the inflow direction and enhanced frictional resistance and pressure resistance in the outflow direction by arranging nonwoven fabrics with different pore distributions on the upper and lower surfaces of the adsorption layer 120. Due to this configuration, the wearer can be effectively protected from chemical, biological, and radiological substances in the form of gases and vapors as well as aerosols, and since sweat and heat generated inside are efficiently discharged to the outside, the fabric can provide the wearer good ventilation, an excellent environment (comfort and convenience) and low thermal fatigue even during long-term activities.

The activated carbon fibers provided in the adsorption layer 120 are intended to provide protective performance against liquids, vapors, aerosols, etc. of chemical agents and/or toxic chemicals, and are prepared through stabilization, carbonization, and activation process of raw materials (raw fibers or fabrics). The raw materials (raw fibers or fabrics) may be raw materials (raw fibers) that are easy to secure durability in order to ensure durability when used as clothing during washing and wearing. For example, the raw materials may include one or more selected from a group consisting of polyacrylonitrile (PAN)-based raw materials, rayon-based raw materials, phenol-based raw materials, and cellulose-based raw materials. For example, the raw material may be a long fiber or a fabric made by weaving or knitting the long fiber, although not being limited thereto. For example, the activated carbon fiber may be prepared using rayon-based raw materials (or fibers or fabrics), stabilizing them at 200° C. to 400° C., carbonizing them at 600° C. or higher, or at 600° C. to 800° C.; and then performing steam activation for 10 minutes or longer, or 10 minutes to 40 minutes.

The activated carbon fibers provided in the adsorption layer 120 are not significantly limited in basis weight, pore structure, or specific surface area. It is because adsorption speed and protective performance against contaminants can be guaranteed along with airtightness and activity since the adsorption layer is provided in the first and second aerosol blocking layers with controlled pore structures even if the basis weight, pore structure, and specific surface area conditions of the activated carbon fibers of the adsorption layer 120 are somewhat low.

Therefore, in the past, only activated carbon fibers with excellent protective performance could be used as the material of the adsorption layer in a multilayer fabric for chemical, biological, radiological, nuclear or explosive protection. However, since the present disclosure overcomes this drawback and can provide remarkable protective performance even when activated carbon fibers are used under a wide range of conditions, the cost of the fabric can be reduced and the activated carbon fibers can be recycled, thus providing excellent economic advantages.

The activated carbon fiber has a basis weight of 200 g/m² to 300 g/m², a specific surface area of 2000 g/m² to 20,000 g/m². It contains 70% to 90% of micropores with a size of 10 μm to 100 μm based on the total pore volume.

The activated carbon fiber of the adsorption layer 120 may further include powder- or bead-type activated carbon. The activated carbon can be fixed to the adsorption layer 120. In the past, activated carbon was applied to flat fibers to increase the protection efficiency a multilayer fabric for chemical, biological, radiological, nuclear or explosive protection. However, there was a problem that the protection efficiency is decreased significantly when it falls off. However, according to the present disclosure, since protective performance is ensured through the control of the pore structure of the first and second aerosol blocking layers although activated carbon is further included in the adsorption layer 120, the activated carbon can be included further in the adsorption layer 120 without concern for the deterioration of the protective performance caused by detachment of activated carbon.

The activated carbon may have a diameter of 0.1 mm to 1.0 mm, a crushing strength of 5 N or higher, and a specific surface area of 1000 g/m² to 2500 g/m², although not being specially limited thereto. The activated carbon may have a total pore volume of 0.5 cm³/g to 1.5 cm³/g, and the pore volume formed by micropores having a diameter of 2 nm or smaller may be 30% to 90% of the total pore volume.

The multilayer fabric for chemical, biological, radiological, nuclear or explosive protection according to the first exemplary embodiment described above exhibited higher protective performance than the protective standard of the JSLIST (Joint Service Lightweight Integrated Suit Technology). It exhibited 30% higher protective effect against gaseous chemical agents and 20 to 35% higher moisture permeability, air permeability, and water vapor resistance, as compared to the conventional multilayer fabric for chemical, biological, radiological, nuclear or explosive protection. These effects were achieved without weight increase. That is, weight reduction was achieved as compared to the effects. In addition, since while maintaining the protective function against gaseous pollutants, it exhibits excellent efficiency of discharging sweat and heat to the outside, thereby reducing increase in thermal fatigue and enabling stable activity for long periods of time, it overcomes the limitations of existing chemical, biological, and radiological protective clothing. In addition, even when the chemical, biological, and radiological protective clothing according to the present disclosure is prepared to fit closely to the wearer in order to provide airtightness for prevention of chemicals from entering the clothing, it can provide the wearer a comfortable environment and activity due to improved air permeability, drying power, etc.

The multilayer fabric for chemical, biological, radiological, nuclear or explosive protection having the structure described above has the effect of having a structure that is firmly fixed internally and externally when the following conditions are met, so that even if exposed to strong explosion pressure or blast pressure due to an external explosion such as a chemical, biological, radiological, nuclear or explosive attack, the pressure gradient structure of the present disclosure is less likely to be destroyed, damaged, or deformed, and even if it is deformed, the pressure gradient structure is restored by the nonwoven fabric structure of the controlled aerosol blocking layer itself when the blast pressure disappears, so that chemical, biological, and radiological protection can be ensured and comfort can be maintained due to air permeability.
\textcircled{1} The nonwoven fabric of the first aerosol blocking layer is a nonwoven fabric having a basis weight of 34 to 35 g/m², in which polyethylene terephthalate (PET) and nylon (nylon 6) are mixed at a weight ratio of 40:60 to 60:40.
\textcircled{2} The nonwoven fabric of the second aerosol blocking layer is a nonwoven fabric having a basis weight of 24 to 25 g/m², in which polyethylene terephthalate (PET) and nylon (nylon 6) are mixed at a weight ratio of 10:90 to 20:80.
\textcircled{3} The nonwoven fabric of the first aerosol blocking layer has a pore distribution with a pore volume having a diameter of 100 μm (dV/d (log D)) of 9-10 when the macropores (75 nm-1100 μm) are measured by mercury porosimetry, and the nonwoven fabric of the second aerosol blocking layer has a pore distribution with a pore volume having a diameter of 100 μm (dV/d (log D)) of 5-6 when the macropores (75 nm-1100 μm) are measured by mercury porosimetry.
\textcircled{4} A thermoplastic polyamide adhesive with a glass transition temperature of 40° C. to 80° C. is applied on one surface in dot form with an amount of 8 to 10 g/m² to a dot density of 20 to 180 dots/cm².

If any of the above conditions is not met, the blocking and protection performance against chemical, biological, and radiological attacks and the comfort due to ventilation are excellent, but it is not desirable because it is impossible to obtain a protective effect against strong explosion pressure or blast pressure caused by an external explosion such as a chemical, biological, radiological, nuclear or explosive attack.

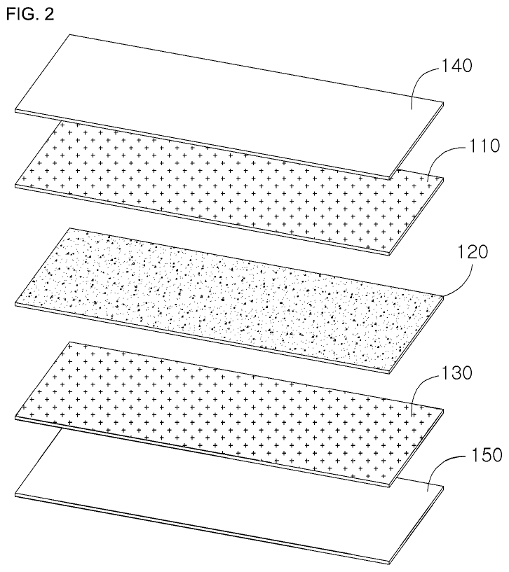

The multilayer fabric for chemical, biological, radiological, nuclear or explosive protection according to a second exemplary embodiment of the present disclosure is different from the first exemplary embodiment described above in that it further includes a support fabric 150 and a cover fabric 140 as shown in FIG. 2. So, only the difference will be explained in the followings.

The cover fabric 140 is further included on the outer surface of the first aerosol blocking layer 110, and the support fabric 150 is arranged on the outer surface of the second aerosol blocking layer 130. Specifically, the second aerosol blocking layer 130, the adsorption layer 120, the first aerosol blocking layer 110, and the cover fabric 140 are sequentially attached to the upper surface of the support fabric 150 to form an integrated fabric so as to block aerosols from coming into contact with the skin at the front surface, while sweat or moisture is released to the outside, thereby providing a lightweight chemical, biological, radiological, and nuclear protective clothing having the excellent protective performance as described above.

Since it is possible to facilitate the wearer's activities by repeating the process of releasing heat or sweat by ensuring good ventilation through the support fabric 150 and the cover fabric 140, it can be used in various places. And, since the first aerosol blocking layer 110 protects the second aerosol blocking layer 130 stably, no additional maintenance cost is required.

The cover fabric 140 is located at the outermost layer of the multilayer fabric for chemical, biological, radiological, nuclear or explosive protection. It may be prepared from any waterproof and heat-dissipating material without particular limitation. Specifically, it may be a fiber or a mixture thereof including one or more of polyester (PES), polyethylene (PE), polypropylene (PP), polyacrylonitrile (PAN), polyamide (PA), polyaramid, polyvinyl alcohol (PVA), polyurethane, polyvinyl ester, acrylate, rayon, nylon and cotton, and may be coated with a water-repellent and oil-repellent agent.

As the water-repellent and oil-repellent agent, C8 or C6 series carbon fluorocarbon products may be used. A specific ratio and a coating method known in the technical field of the present disclosure may be used, although not being limited thereto.

The support fabric 150 is a part of the multilayer fabric for chemical, biological, radiological, nuclear or explosive protection that comes into contact with the wearer's skin. It is not particularly limited as long as it is a material used as a lining. Specifically, it may include a fabric prepared one or more material selected from a group consisting of polyester, nylon, polyamide, polyvinyl chloride, polyketone, polycarbonate, fluoropolymer, polyacrylate, polyurethane and polypropylene, or a mixed fabric thereof. Specifically, polyester and nylon may be used. The support fabric 150 may be selected in consideration of the required strength and overall weight level, and specifically may have a basis weight of 10 g/m² to 100 g/m².

The support fabric 150 may be a hydrophobic fiber substrate, and by forming a wettability gradient in consideration of the wettability of the nonwoven adsorption layer and the support fabric layer, heat and sweat generated within the body can be easily discharged to the outside.

According to the second exemplary embodiment described above, the wearer can be more safely protected from various chemical agents through the water-repellent and oil-repellent properties of the support fabric 150 and the cover fabric 140. In addition, by shielding the outer surfaces of the first and second aerosol blocking layers with the support fabric 150 and the cover fabric 140, an air layer is provided between the first and second aerosol blocking layers, thereby improving insulation performance.

The multilayer fabric for chemical, biological, radiological, nuclear or explosive protection according to the first and second exemplary embodiments described above is prepared into a chemical, biological, and radiological protection clothing, a chemical, biological, and radiological gas mask, a canister, a combat uniform, a field tent, a camouflage net, a police uniform, and an industrial protective clothing. In this case, the multilayer fabric for chemical, biological, radiological, nuclear or explosive protection can be used as the outer fabric or shell of the chemical, biological, and radiological protection clothing, or alternatively, it can be used as the lining or inner fabric.

The multilayer fabric for chemical, biological, radiological, nuclear or explosive protection is used so that the first aerosol blocking layer 110 is used as the surface exposed to the external environment, and the second aerosol blocking layer 130 is used as the inner surface facing the wearer's skin.

In addition, since the prepared chemical, biological, and radiological protection clothing has improved durability and all-weather chemical, biological, and radiological protective performance due to the components of the first and second aerosol blocking layers and the adsorption layer, has excellent comfort of wearing, high durability and short wearing time, provides airtightness and excellent activity without weight increase, and has excellent air permeability and drying power as well as preventing penetration of sharp objects, the wearer can be protected from various threats.

Another aspect of the present disclosure relates to a multilayer fabric for chemical, biological, radiological, nuclear, radiological, explosive (CBRNe) protection.

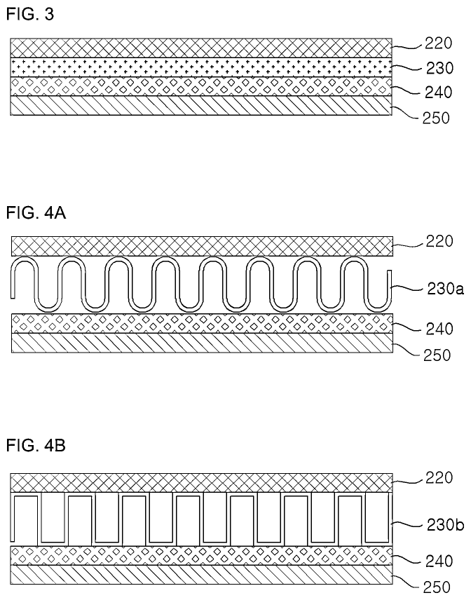

A multilayer fabric for chemical, biological, radiological and explosive protection according to the third exemplary embodiment of the present disclosure includes a first aerosol blocking layer 220, an adsorption layer 230, a shock absorption layer 240, and a radiation shielding layer 250, as shown in FIG. 3.

The first aerosol blocking layer 220 is provided with a fabric, knitted fabric or nonwoven fabric made from any one thermoplastic polymer having aerosol particle blocking property.

The first aerosol blocking layer 220 is not particularly limited as long as it is a fabric, knitted fabric or nonwoven fabric prepared from any thermoplastic polymer having aerosol particle blocking property. Specifically, it may be a fabric, knitted fabric or nonwoven fabric prepared using one or more selected from a group consisting of polyurethane (PU), polypropylene (PP), polyester, polyethylene (PE), polyethylene terephthalate (PET), nylon (nylon 6), and viscose rayon. Most specifically, it may be a mixed nonwoven fabric prepared from polyethylene terephthalate (PET) and nylon (nylon 6).

In the present disclosure, the nonwoven fabric refers to a fabric in which the fibers contained have no longitudinal or transverse directionality, and the mixed nonwoven fabric refers to a nonwoven fabric formed by mixing two types of fibers obtained using different thermoplastic resins.

The mixing ratio of polyethylene terephthalate and nylon may be specifically 10:90 to 70:30 based on weight. If the weight ratio of the polyethylene terephthalate is lower than 10, tensile strength may decrease. And if it exceeds 70, the comfort of wearing may be poor due to rough texture and high tensile strength, and fuzzing may occur during washing.

When a mixed nonwoven fabric prepared from polyethylene terephthalate (PET) and nylon (nylon 6) is used as the first aerosol blocking layer 220, it not only provides protection against aerosols and blocks and removes radioactive particles and viruses/biological agents, but also has good air permeability and dries quickly to efficiently discharge sweat and heat generated inside to the outside, thereby ensuring comfort. In addition, it provides excellent activity through improved flexibility.

The basis weight of the first aerosol blocking layer 220 may be specifically in the range of 10 to 120 g/m², and more specifically in the range of 20 to 60 g/m². If the basis weight of the first aerosol blocking layer 220 is less than 10 g/m², the properties of the adsorption layer 230 with low tensile strength cannot be reinforced, resulting in damage of the adsorption layer caused by the wearer's activities. If the basis weight exceeds 120 g/m², the weight of the multilayer fabric for chemical, biological, radiological, nuclear or explosive protection increases, resulting in reduced lightweightness and flexibility when preparing a protective clothing.

The nonwoven fabric is not particularly limited in its preparation process. Specifically, a dry nonwoven fabric such as a chemically bonded nonwoven fabric, a thermally bonded nonwoven fabric, an air-laid nonwoven fabric, etc., a wet nonwoven fabric, a spanless nonwoven fabric, a needle-punched nonwoven fabric, or a melt-blown nonwoven fabric can be used. More specifically, it can be obtained by electrospinning a polymer solution containing fibers, and the electrospinning may be specifically performed at a voltage of 5 to 20 V. The mixed nonwoven fabric prepared through the above process can be prepared into a sheet form through a pressing process.

Specifically, a step of densifying the mixed nonwoven fabric may be further included, and the densification may be performed by a belt press (BP) process or a calendering (CA) process. The belt press process is a process in which a nonwoven fabric is passed between two upper and lower heating belts, and the surface flatness of the nonwoven fabric is increased and a dense structure is provided by applying preset temperature and pressure. The calendering process is a process of heating and pressurizing a nonwoven fabric by passing it between two rotating heating rollers to make it denser.

The first aerosol blocking layer 220 may be composed of a single layer or multiple layers. When prepared as multiple layers to provide rigidity to the multilayer fabric for chemical, biological, radiological, nuclear or explosive protection according to the present disclosure, the basis weights of the nonwoven fabrics may be the same or different. When the first aerosol blocking layer 220 is a single layer, the thickness may be 300 μm or smaller, specifically 100 to 300 μm, and more specifically 200 to 300 μm. When the first aerosol blocking layer 220 is multiple layers, protective power and rigidity increase as the number of layers increases. However, if the number of the layers is too large, the air permeability and moisture permeability of the entire chemical, biological, and radiological protection fabric may decrease, and activity may be restricted due to weight increase. Therefore, in order to increase protective power against aerosols while minimizing air permeability, moisture permeability, and weight increase, the first aerosol blocking layer 220 may be configured as a single layer or multiple layers depending on the intended use and desired effect.

The adsorption layer 230 is a portion where an external chemical toxic substance (e.g., aerosol, liquid, gas, or vapor-type chemical agent) is adsorbed. It is positioned below the first aerosol blocking layer 220.

Specifically, the adsorption layer 230 may be fixed to the first aerosol blocking layer 220 using an adhesive, so as to help reinforce the weak tensile strength of the adsorption layer. In addition, the adsorption layer 230 can be fixed and arranged not only on the first aerosol blocking layer 220 but also on the shock absorption layer 240 located below the adsorption layer 230 so that the activated carbon fiber can be fixed within the fabric.

The adsorption layer 230 is not particularly limited in structure as long as it can be used in chemical, biological, radiological, nuclear or explosive protection fabrics. It may have a flat structure or a wrinkle structure.

The adsorption layer 230 is not particularly limited as long as it is an activated carbon fiber that adsorbs external chemical toxic substances. Specifically, the activated carbon fiber may be prepared by stabilization, carbonization and activation processes of a raw material (raw fiber or fabric) to provide protective performance against liquids, vapors and aerosols of chemical agents and/or toxic chemicals, and the raw material (raw fiber or fabric) may be a raw material (raw fiber) that is easy to secure durability in order to ensure durability during washing and wearing when used for a clothing. It may include, for example, one or more selected from a group consisting of polyacrylonitrile (PAN)-based raw materials, rayon-based raw materials, phenol-based raw materials and cellulose-based raw materials. For example, the raw material may be a long fiber or a fabric made by weaving or knitting the long fiber, although not being limited thereto. For example, the activated carbon fiber may be prepared using rayon-based raw materials (or fibers or fabrics), stabilizing them at 200° C. to 400° C., carbonizing them at 600° C. or higher, or at 600° C. to 800° C.; and then performing steam activation for 10 minutes or longer, or 10 minutes to 40 minutes.

The adsorption layer 230 is specifically an activated carbon fiber having a basis weight of 200 g/m² to 300 g/m², a specific surface area of 2,000 g/m² or more, a volume of micropores of 2 nm or less of 60% or more of the total pore volume, and pores of 10 μm to 100 μm, more specifically, it may have a basis weight of 200 g/m² to 300 g/m², a specific surface area of 2,000 g/m² to 20,000 g/m², and may contain 70% to 90% of micropores with a size of 0.2 nm to 2 nm based on the total pore volume.

The activated carbon fiber of the adsorption layer 230 may further include powder- or bead-type activated carbon. The activated carbon can be fixed to the adsorption layer 230. The activated carbon may have a diameter of 0.1 mm to 1.0 mm, a crushing strength of 5 N or higher, and a specific surface area of 1000 g/m² to 2500 g/m², although not being specially limited thereto. The activated carbon may have a total pore volume of 0.5 cm³/g to 1.5 cm³/g, and the pore volume formed by micropores having a diameter of 2 nm or smaller may be 30% to 90% of the total pore volume.

An adhesive is disposed between the first aerosol blocking layer 220 and the adsorption layer 230. Specifically, an adhesive is applied to the surface of the first aerosol blocking layer 220 that comes into contact with the adsorption layer 230. The adhesive is applied in dot form. The adhesive can improve the protective performance against contaminants (liquid, vapor, and aerosol chemical agents, radioactive particles, and viruses/biological agents) by attaching to and fixing the first aerosol blocking layer 220 and the adsorption layer 230, and the reduction in specific surface area can be minimized by minimizing the bonding area with the adhesive.

The adhesive is not particularly limited as long as it can be fixed firmly to the adsorption layer 230. Specifically, it may be one or more selected from a group consisting of polyethylene (HDPE, LDPE), polyamide (PA), polyurethane (PU), and polyester (PES). More specifically, a polyamide adhesive having a glass transition temperature of 40° C. to 80° C. may be used.

In addition, the adhesive is applied in dot form on the lower surface of the first aerosol blocking layer 200 so that the adsorption layer 230 is fixed to the first aerosol blocking layer 220, and it is preferable that the dot density is in the range of 20 to 180 dots/cm² and the application amount is in the range of 8 to 10 g/m². If the dot density exceeds 180 dots/cm² or if the application amount exceeds 10 g/m², a problem may occur in which the adhesive coagulates to form a film. In this case, the air permeability of the fabric itself may be reduced, and residual adhesive may seep into the first aerosol blocking layer 200, reducing the overall flexibility and elasticity of the fabric.

And, if the dot density exceeds 20 dots/cm² or if the application amount is less than 8 g/m², the adsorption layer 230 is not stably fixed to the first aerosol blocking layer 220. Therefore, it is desirable to satisfy the above-described condition.

When an adhesive is provided to satisfy the above-described condition, the adhesive can be firmly fixed to the first aerosol blocking layer 220 while minimizing the decrease in the specific surface area of the adsorption layer 230, thereby improving flexibility while maintaining the ventilation and protective functions of the fabric.

The shock absorbing layer 240 is a layer including a viscoelastomer having the function of absorbing and dispersing shock, which is arranged under the adsorption layer 230. It is not particularly limited as long as it has the function of absorbing and dispersing shock energy.

The viscoelastomer is a material having both elasticity and viscosity. Specifically, it is preferred that the viscoelastomer has a shear stress of 200 Pa when a shear force is applied, and a loss factor of 1 or greater when a wave is applied. Specifically, the viscoelastomer may be one or more selected from a group consisting of polytetrafluoroethylene (PTFE), low-density polyethylene (LDPE), polyvinyl alcohol (PVA), polyvinyl chloride (PVC), and polyurethane (PU). More specifically, polyvinyl alcohol (PVA) may be used alone.

As the viscoelastomer, i. a hydrophilic polymer having a functional group capable of hydrogen bonding; and ii. a deep eutectic solvent (DES) can be used so that the network structure and mechanical properties can be changed upon absorption of chemical, biological, and radiological agents and, not only chemical, biological, and radiological agents but also physical impacts can be blocked through such changes.

In the viscoelastomer, the mixing weight ratio of the hydrophilic polymer having the functional group capable of hydrogen bonding and the eutectic solvent may be specifically 0.5:1 to 1.5:1. Outside the above range, problems such as reduced durability and shock absorption performance may occur. The functional group capable of hydrogen bonding may include a hydroxyl group (—OH), a carboxyl group (—COOH), a carboxylamide group (—CONH₂), an amine group (—NH₂), etc.

The hydrophilic polymer having a functional group capable of hydrogen bonding (i) may be one or more selected from a group consisting of polyvinyl alcohol (PVA), polyvinylamine, polyvinylamide, polyacrylamide, polyacrylic acid, and polyamine. Specifically, it may be polyvinyl alcohol (PVA). All types of commercially available PVA can be applied without any special limitation.

Specifically, the mixing weight ratio of the hydrophilic polymer having a functional group capable of hydrogen bonding and the eutectic solvent may be 0.8:1 to 1.2:1.

The deep eutectic solvent is a mixture of two or more salts or ionic substances. It collectively refers to a substance that can be utilized at relatively low temperatures because its melting point is lower than that of each component. As a typical example, a deep eutectic solvent prepared by mixing choline chloride (hydrogen bond acceptor) and a natural substance such as urea or glycerin (hydrogen bond donor) has a significantly lower melting point than those of the parent components.

Deep eutectic solvents are similar to ionic liquids in physicochemical properties such as viscosity, volatility, and density.

The deep eutectic solvent is not particularly limited as long as it is a deep eutectic solvent including choline chloride and glycerin. The mixing molar ratio of choline chloride and glycerin may be specifically 1:1.5 to 1:2.5, more specifically 1:1.8 to 1:2.2. If the mixing molar ratio is lower than 1:1.8 or exceeds 1:2.2, hydrogen bond may not be formed since the adsorption of the chemical, biological, radiological, nuclear or explosive agent may not occur properly depending on the preparation process and conditions, such as the type of the polymer or the mixing ratio of the polymer and the eutectic solvent. As a result, a problem may occur in which the effect of dispersing shock cannot be achieved.

The viscoelastomer composed of i and ii absorbs chemical, biological, radiological, nuclear or explosive agents to protect the wearer, and has the function of absorbing or dispersing physical impact. In particular, when exposed to chemical, biological, radiological, nuclear or explosive agents, hydrogen bonds are formed between polymer chains by adsorbing the chemical, biological, radiological, nuclear or explosive agents, which allow the polymer to not only absorb but also disperse physical impact.

The viscoelastomer composed of i and ii has the effects of simultaneously improving heat resistance against explosion, absorbing shock only from explosion but also from fragments, discharging moisture, and protecting from chemical resistances when the conditions \textcircled{1} to \textcircled{3} described below are satisfied:
\textcircled{1} The mixing weight ratio of the hydrophilic polymer having a functional group capable of hydrogen bonding and the eutectic solvent is 0.8:1 to 1.2:1.
\textcircled{2} The molar ratio of choline chloride and glycerin is 1:1.8 to 1:2.2.
\textcircled{3} The hydrophilic polymer having a functional group capable of hydrogen bonding is polyvinyl alcohol.

However, if a different polymer is used, if a eutectic solvent having different components or composition is used, or if any one of the above content range is not satisfied, although some of the properties such as heat resistance to prevent explosion, shock absorption not only from explosion but also from fragments, release of moisture, and chemical resistance are improved, other properties are deteriorated. Therefore, it is not desirable in that the effect of simultaneously improving heat resistance, penetration resistance against sharp fragments, moisture release, and chemical resistance cannot be obtained.

The viscoelastomer is not particularly limited in form. But, specifically it may be in the form of a thin film, a fabric, a knitted fabric, or a nonwoven fabric.

In addition, the shock absorbing layer 240 may further include an inorganic fiber or a glass fiber to supplement compressive strength. In this case, the viscoelastomer may be used in the form of a fiber-reinforced composite material in which the viscoelastomer is coated on an inorganic fiber or a glass fiber. The inorganic fiber is not particularly limited. But, carbon fiber having flexibility is preferred.

Traditionally, negative Poisson materials have been used for shock absorption. Whereas conventional negative Poisson materials only have a shock absorbing function, the shock absorption layer of the present disclosure described above not only helps to absorb chemical, biological, radiological, nuclear or explosive agents, but also absorbs and disperses impact energy, thereby safely protecting the wearer from impacts such as explosives.

In the present disclosure, the Poisson's ratio means the ratio of compression and expansion in the vertical direction when force is applied. Some materials have negative Poisson's ratios (NPR), which means that when force is applied, the material shrinks in the vertical direction as well, and when pulled, the material expands in the vertical direction as well.

The radiation shielding layer 250 is made of tungsten or boron nanoparticles having radiation shielding properties, and may be a material in which tungsten or boron nanoparticles are applied or coated on the shock-absorbing layer 240, may be a fabric prepared by coating tungsten or boron nanoparticles on a fabric, may be a processed product in the form of a sheet or film prepared by mixing with a polymer material, or may be a fabric, knitted fabric, or nonwoven fabric composed of a yarn that is melt-spun after mixing tungsten or boron nanoparticles with a polymer resin.

Specifically, the radiation shielding layer 250 may be a fabric prepared by coating tungsten or boron nanoparticles on a fabric, and is not particularly limited as long as it is a fabric that is flexible and elastic.

The average diameter of the tungsten or boron nanoparticles is specifically 40 to 1000 nm, and the polymer material may be one or more selected from a group consisting of low-density polyethylene (LDPE), high-density polyethylene (HDPE), polyvinyl alcohol (PVA), polyethylene terephthalate (PET), polyurethane (PU), silicone resin, and epoxy resin.

The tungsten or boron nanoparticles used for radiation shielding are generally available only in the form of a film. But, in the present disclosure, as the radiation shielding layer is arranged under the shock-absorbing layer 250 including the viscoelastomer, sufficient effects can be obtained only with tungsten or boron nanoparticles. In addition, it can be applied in various forms such as a fabric coated on a fabric, a film, a knitted fabric, or a nonwoven fabric, so that the wearer's convenience can be guaranteed along with lightweightness.

The multilayer fabric for chemical, biological, radiological and explosive protection according to a third exemplary embodiment may further include a cover fabric 210, which is arranged on the outer surface of the multilayer fabric for chemical, biological, radiological and explosive protection to primarily block aerosols from contacting the skin from the front, while preventing the multilayer fabric for chemical, biological, radiological and explosive protection from being exposed to the external environment, thereby improving durability and helping to eliminate the need for additional maintenance cost. An example of a configuration that further includes a cover fabric 210 can be seen in a fifth exemplary embodiment.

Since the cover fabric 210 is positioned on top of the first aerosol blocking layer 220 and is located at the outermost layer of the multilayer fabric for chemical, biological, radiological, nuclear or explosive protection, it may be specifically made of a waterproof and heat-resistant material. Specifically, it may be a fiber or a mixture thereof including one or more of polyester (PES), polyethylene (PE), polypropylene (PP), polyacrylonitrile (PAN), polyamide (PA), polyaramid, polyvinyl alcohol (PVA), polyurethane, polyvinyl ester, acrylate, rayon, nylon and cotton, and may be coated with a water-repellent and oil-repellent agent.

As the water-repellent and oil-repellent agent, C8 or C6 series carbon fluorocarbon products may be used. A specific ratio and a coating method known in the technical field of the present disclosure may be used, although not being limited thereto.

The multilayer fabric for chemical, biological, radiological and explosive protection according to the third exemplary embodiment described above exhibited higher protective performance than the protection standard of JSLIST (Joint Service Lightweight integrated Suit Technology), and unlike conventional chemical, biological and radiological protective fabrics, it simultaneously has a shielding effect against explosion and radiation, and also has excellent moisture permeability, air permeability and water vapor resistance. In addition, since the weight increase is relatively low compared to these effects, it can effectively protect the wearer in chemical, biological, radiological, nuclear, and explosive (CBRNE) disaster situations without additional equipment, and can be worn not only under regular combat uniforms but also everyday clothes because it causes little restriction or interference during evacuation or activities. Since the multilayer fabric for chemical, biological, radiological and explosive protection according to the present disclosure has improved air permeability, lightweightness and drying power, it can provide a comfortable environment and activity to the wearer.

In the third exemplary embodiment of the present disclosure, the viscoelastomer composed of i and ii used in the shock absorbing layer 240 may be prepared by a process including:
A. a step of mixing i. a hydrophilic polymer having a functional group capable of hydrogen bonding; and ii. a deep eutectic solvent; and B. a step of reacting the mixture at 50 to 100° C.

Specifically i. a hydrophilic polymer having a functional group capable of hydrogen bonding; and ii. a deep eutectic solvent (DES) are mixed.

The mixing weight ratio of the hydrophilic polymer having the functional group capable of hydrogen bonding and the eutectic solvent may be 0.5:1 to 1.5:1, more specifically 0.8:1 to 1.2:1. Outside the above range, a problem may occur that it is impossible to obtain a fiber or thin film with sufficient strength and properties during the subsequent fabric preparation.

The deep eutectic solvent may be prepared by mixing choline chloride (ChCl) and glycerin and heat-treating the mixture. The mixing molar ratio of choline chloride (ChCl) and glycerin may be 1:1.5 to 1:2.5, more specifically 1:1.8 to 1:2.2. If the mixing molar ratio is lower than 1:1.8 or exceeds 1:2.2, hydrogen bonds may not be formed as the chemical, biological, and radiological agent may not be adsorbed properly. Therefore, the effect of dispersing shock may not be achieved.

The heat treatment condition in the process of preparing the deep eutectic solvent may be 40 to 90° C., or specifically 70 to 85° C. When the above heat treatment condition is satisfied, the formation of hydrogen bonds between choline chloride and glycerin, which is an endothermic process, is promoted.

The deep eutectic solvent prepared through the above-described process has water absorption capacity and its melting point varies depending on the degree of water absorption. The melting point of the deep eutectic solvent may be from −10° C. to 90° C., specifically from 0° C. to 70° C., more specifically from 0° C. to 10° C.

In the next step B, the heat treatment condition for the mixture may be 20 to 100° C., specifically 50 to 90° C. If the heat treatment is below 50° C. or exceeds 90° C., a problem may arise in that the effect of dispersing physical impact cannot be obtained.

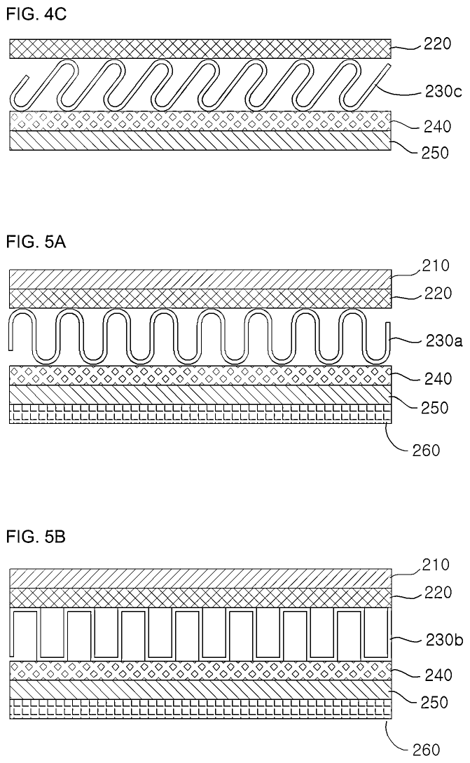

The difference between the multilayer fabric for chemical, biological, radiological and explosive protection according to the fourth exemplary embodiment of the present disclosure and that of the third exemplary embodiment is that the adsorption layer 230 has a wrinkle structure as shown in FIGS. 4A, 4B and 4C. So, only the difference will be explained in the followings.

The adsorption layer 230a, 230b, 230c may have a wrinkle-free structure or a structure with wave-shaped continuous wrinkles depending on the desired performance of the activated carbon fiber for adsorbing external chemical toxic substances, and is arranged between the first aerosol blocking layer 220 and the shock absorbing layer 240 so that the adsorption layer is fixed.

The adsorption layer 230a, 230b, 230c includes activated carbon fibers that are continuously wrinkled in a wave shape, and is attached and fixed between the first aerosol blocking layer 220 and the shock-absorbing layer 240 by a thermoplastic adhesive such as polyamide, so that the improved surface area of the adsorption layer 230a, 230b, 230c can improve the protection performance against contaminants (liquid, vapor and aerosol chemical agents, radioactive particles, and viruses/biological agents), and can also minimize the reduction in specific surface area by minimizing the bonding area with the adhesive. Moreover, since the protective function can be maximized with only activated carbon fibers of small weight, rather than activated carbon powder, the restriction of movement can be reduced.

For the chemical agents, since chemical agents spread in the form of particles (aerosol phase) or fog of about 0.001 to 1000 μm in size, and appear in the form of vapor after a certain period of time, it is desirable for the protective performance to work for both the aerosol and fog forms. However, conventional protective clothing is based on the principle of primary protection from the outer skin and secondary absorption from the inner skin, and has little consideration for the protective effect against hazardous chemicals during dynamic activities.

On the other hand, the multilayer fabric for chemical, biological, radiological, nuclear or explosive protection according to the present disclosure is advantageous in that, since the wrinkled absorption layer 230a, 230b, 230c is fixed to the first aerosol blocking layer 220 having elasticity by the adhesive in dot form only at the curved portion facing the first aerosol blocking layer 220 so as to provide spatiality, even if the clothing is prepared to cover the upper or lower body or the entire body of the wearer, it provides activity through effective flexibility for areas with a lot of movement such as the waist, arms, elbows, armpits, groin, knees, etc., provides excellent airtightness for the wrists, ankles and neck, thereby providing convenience for dynamic movement and protection performance against hazardous chemicals and pollutants during dynamic activities.

The adsorption layer 230a, 230b, 230c can also be joined with the shock absorption layer 240 disposed underneath by an adhesive in dot form, and at this time, it is preferable that only the curved portion of the wrinkle structure is fixed. For this purpose, it is preferable to apply the adhesive in dot form to the shock absorbing layer 240. When the adsorption layer 230a, 230b, 230c is maintained in a fixed state by the layers located at the upper and lower portions, it can be made to bend in various directions in response to a force applied to the fabric, and also can protect the wearer by preventing penetration of a sharp object.

The activated carbon fibers provided in the adsorption layer 230a, 230b, 230c are intended to provide protective performance against liquids, vapors, aerosols, etc. of chemical agents and/or toxic chemicals, and are prepared through stabilization, carbonization, and activation processes of raw materials (raw fibers or fabrics). The raw materials (raw fibers or fabrics) may be raw materials (raw fibers) that are easy to secure durability in order to ensure durability during washing and wearing when used for a clothing. For example, one or more selected from a group consisting of polyacrylonitrile (PAN)-based raw materials, rayon-based raw materials, phenol-based raw materials, and cellulose-based raw materials may be used. For example, the raw material may be a long fiber or a fabric made by weaving or knitting the long fiber, although not being limited thereto. For example, the activated carbon fiber may be prepared using rayon-based raw materials (or fibers or fabrics), stabilizing them at 200° C. to 400° C., carbonizing them at 600° C. or higher, or at 600° C. to 800° C.; and then performing steam activation for 10 minutes or longer, or 10 minutes to 40 minutes.

The activated carbon fibers provided in the adsorption layer 230a, 230b, 230c are not significantly limited in basis weight, pore structure, and specific surface area. This is advantageous in that, because the adsorption layer 230a, 230b, 230c having a wrinkle structure is provided in the first aerosol blocking layer, even when the basis weight, pore structure, and specific surface area of the activated carbon fibers of the adsorption layer 230a, 230b, 230c are somewhat low, adsorption speed and protective performance against pollutants can be ensured along with airtightness and activity.

Therefore, although only activated carbon fibers with excellent protective performance could be used as a material for the adsorption layer in multilayer fabrics for chemical, biological, radiological, nuclear or explosive protection in the past, the present disclosure overcomes this drawback and can provide remarkable protective performance even when activated carbon fibers are used under a wide range of conditions. This is advantageous in economic terms because the cost of the fabric can be reduced and the activated carbon fibers can be recycled.

The activated carbon fiber may have a basis weight of 10 g/m² to 200 g/m², a specific surface area of 2000 g/m² to 20,000 g/m², and may contain 70% to 90% of micropores with a size of 0.2 nm to 2 nm based on the total pore volume.

The height, width or spacing of the wrinkle structure of the activated carbon fiber formed in the adsorption layer 230a, 230b, 230c is not particularly limited. Specifically, a wrinkle structure may be formed by applying physical force. More specifically, it may have an average height within a range of 5 to 50 nm, and a width within a range of 5 to 50 nm. Additionally, the wrinkle structure can have an average spacing between wrinkles in a range of 1 to 50 nm.

The multilayer fabric for chemical, biological, radiological and explosive protection according to the present disclosure is formed by including a wrinkle structure only in the absorption layer 230a, 230b, 230c. In other words, the first aerosol blocking layer 220 and the shock absorbing layer 240 to which the adsorption layer 230a, 230b, 230c is fixed are formed to include a structure having a flat surface with no wrinkle structure. Accordingly, a portion of the surface of the wrinkle structure of the adsorption layer 230a, 230b, 230c and a portion of the surface of the flat first aerosol blocking layer 220 and the shock absorbing layer 240 come in contact with each other and are fixed by an adhesive.

The wrinkle structure of the adsorption layer 230a, 230b, 230c illustrated in FIGS. 4A, 4B, and 4C can be arranged in the form of a wrinkle structure having a round curve 230a, a wrinkle structure having a square-shaped block 230b, or an inclined wrinkle structure 230c. Depending on the purpose of use or need, the shape of the wrinkle structure can be formed as a wrinkle structure having a round curve 230a, a wrinkle structure having a square-shaped block 230b, or an inclined wrinkle structure 230c using different molds or stretching methods. The shape and configuration of the wrinkle structure are not particularly limited, but it is preferable to have a wrinkle shape regularly formed to have a continuous wave shape along the length direction or to have an inclined wrinkle structure.

As shown in FIGS. 4B and 4C, the wrinkle structure of the adsorption layer 230a, 230b, 230c may be a wrinkle structure having a square-shaped block 230b or an inclined wrinkle structure 230c.

In particular, as shown in FIG. 4C, the inclined wrinkle structure 230c of the adsorption layer 230c is usually wrinkled to have an angle of 30 to 50° from the bottom surface. The adsorption layer 230c having an inclined wrinkle structure has a larger specific surface area than the wrinkle structure having a round curve or the wrinkle structure having a square-shaped block. In addition, detachment at the interface can be prevented because of increased interfacial bonding force between the first aerosol blocking layer 220 and the shock absorbing layer 240, and the highest airtightness and activity can be provided.

More specifically, the inclined wrinkle structure of the adsorption layer 230c is formed as an inclined wrinkle shape having an angle of 30-50° toward the line of sight in an opposing position, thereby dramatically improving movement up to an angle of 180°, so that breakage/damage or deterioration of protective performance does not occur even when movement is made at various angles, and stability can be maintained continuously for a long period of time even under physical force such as washing. Therefore, the wearer experiences reduced discomfort when wearing it, which not only improves mobility but also allows them to work for long periods of time.

The activated carbon fiber of the adsorption layer 230a, 230b, 230c may further include powder- or bead-type activated carbon. The activated carbon can be fixed to a curved portion of the wrinkle structure of the adsorption layer 230a, 230b, 230c. In conventional multilayer fabrics for chemical, biological, radiological, nuclear or explosive protection, activated carbon is distributed on the surface or inside of flat fibers or activated carbon fibers. However, since it is not fixed properly, it easily falls off during activities such as moving, washing, shaking, etc. However, according to the present disclosure, since activated carbon can be fixed at the curved portion formed by the wrinkle structure of the adsorption layer 230a, 230b, 230c, the durability of the structurally vulnerable activated carbon can be supplemented, thereby ensuring washing, operational durability, and activity. In particular, the adsorption layer 230c may specifically have an inclined wrinkle structure. As can be seen from FIG. 4C, the inclined wrinkle structure is strongly pressed by the layers located at the upper and lower portions of the adsorption layer 230c (first aerosol blocking layer 220, shock absorbing layer 240), so that the curved portion of the wrinkle structure is locked, and the activated carbon is fixed within the adsorption layer 230c without an additional process. If the activated carbon is exposed inside the adsorption layer 230c and fills the empty space, the activated carbon may prevent the wrinkle structure of the adsorption layer 230c from bending or warping in response to the wearer's movement, or may be detached, thereby reducing the protective performance.

The activated carbon may have a diameter of 0.1 mm to 1.0 mm, a crushing strength of 5 N or higher, and a specific surface area of 1000 g/m² to 2500 g/m², although not being specially limited thereto. The activated carbon may have a total pore volume of 0.5 cm³/g to 1.5 cm³/g, and the pore volume formed by micropores having a diameter of 2 nm or smaller may be 30% to 90% of the total pore volume.

The multilayer fabric for chemical, biological, radiological and explosive protection according to the present disclosure is advantageous in that the activated carbon can be fixed simply by positioning it at the curved portion of the wrinkle structure of the adsorption layer 230a, 230b, 230c without the need of adding a separate configuration.

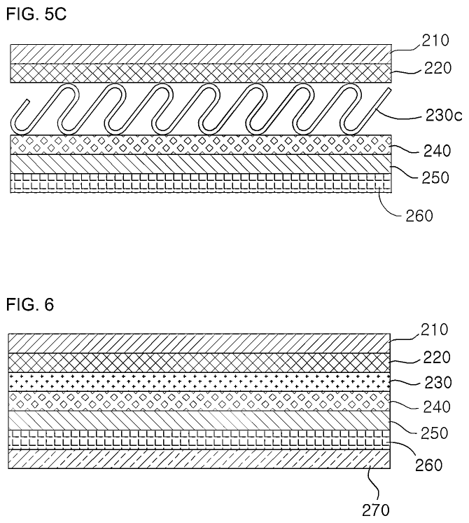

The multilayer fabric for chemical, biological, radiological and explosive protection according to a fifth exemplary embodiment of the present disclosure is different from the fourth exemplary embodiment described above in that it further includes a second aerosol blocking layer 260, as shown in FIGS. 5A, 5B and 5C. So, only the difference will be explained in the followings.

The second aerosol blocking layer 260 may be further included between the adsorption layer 230a, 230b, 230c and the shock-absorbing layer 240, between the shock-absorbing layer 240 and the radiation shielding layer 250, or on the lower surface of the radiation shielding layer 250, as illustrated in FIGS. 5A to 5C.

The second aerosol blocking layer 260 is attached to the lower portion of the adsorption layer 230a, 230b, 230c, and it is composed of a nonwoven fabric prepared from a thermoplastic polymer fiber having a basis weight 0.5 to 0.8 times lower than that of the first aerosol blocking layer 220.

The second aerosol blocking layer 260 may be prepared from one or more selected from the materials mentioned in the first aerosol blocking layer 220 described above. However, as described above, it is preferable that the second aerosol blocking layer 260 is a nonwoven fabric composed of a thermoplastic polymer fiber having a basis weight 0.5 to 0.8 times lower than that of the first aerosol blocking layer 220.

The material of the second aerosol blocking layer 260 may be the same as or different from the first aerosol blocking layer 220, and it is preferable to use the same material but with a different mixing ratio. Specifically, the first aerosol blocking layer 220 may be a nonwoven fabric in which polyethylene terephthalate (PET) and nylon (nylon 6) are mixed at a weight ratio of 40:60 to 60:40, and the second aerosol blocking layer 260 may be a nonwoven fabric in which polyethylene terephthalate (PET) and nylon (nylon 6) are mixed at a weight ratio of 10:90 to 20:80. In this case, the overall life characteristics of the fabric can be improved due to the physical properties of a strong structure. In addition, since the above-described configuration controls the wetness of the fabric from the skin to the outside without a support fabric or a cover fabric, thereby promoting moisture permeation, the fabric can effectively release moisture generated from the skin to the outside while being lightweight and prevented from becoming wet.

The multilayer fabric for chemical, biological, radiological, nuclear or explosive protection according to the present disclosure can provide protective performance not only against aerosol chemical agents but also against vapor or gaseous chemical agents by controlling the pore structure of the first aerosol blocking layer 220 and the second aerosol blocking layer 260 arranged on both sides of the adsorption layer 230a, 230b, 230c, and has excellent air permeability, moisture permeability, water vapor resistance, and lightweightness. Therefore, the effect of improving the convenience and protective performance of a chemical, biological, and radiological protection clothing may be provided simultaneously. In addition, the multilayer fabric for chemical, biological, radiological, nuclear or explosive protection according to the present disclosure is highly commercializable because it does not require an additional processing process or preparation process for improvement of the characteristics described above.

In particular, the multilayer fabric for chemical, biological, radiological, nuclear or explosive protection according to the present disclosure not only improves the all-weather protective performance against aerosols as well as gaseous and vaporous chemical, biological, and radiological contaminants by controlling the pore structure of the first aerosol blocking layer 220 and the second aerosol blocking layer 260, but also has excellent air permeability and heat transfer characteristics due to high air permeability, moisture permeability, and water vapor resistance in addition to the improved protective performance without weight increase. Therefore, thermal fatigue due to activity does not accumulate but is regulated quickly, thereby maintaining a comfortable state.

The nonwoven fabric pore structure of the second aerosol blocking layer 260 can be achieved by changing the first aerosol blocking layer 220. The pore structure of the nonwoven fabric can be controlled with the basis weight of the nonwoven fabric. The basis weight of the nonwoven fabric can be adjusted with an electrospinning condition during the preparation of the nonwoven fabric or heating and pressurizing conditions during a densification process.

In order to improve the effect of removing chemical agents in the form of aerosols, liquids, gases and vapors while facilitating ventilation and discharge of sweat and heat by controlling the pore structure by the pressure gradient of the nonwoven fabric at the same time, it is preferable to arrange the first aerosol blocking layer 220 and the second aerosol blocking layer 260 having different pore structures on both sides of the adsorption layer 230a, 230b, 230c.

In addition, the second aerosol blocking layer 260 may include an adhesive on the upper surface, lower surface, or both surfaces, like the first aerosol blocking layer 220. Through this, the separation of the second aerosol blocking layer 260 from other layers due to different elasticity can be prevented in advance by increasing the bonding strength between the second aerosol blocking layer 260 and other layers.

The second aerosol blocking layer 260 may be a nonwoven fabric composed of a thermoplastic polymer fiber having aerosol particle blocking property and having a basis weight 0.5 to 0.8 times lower than that of a nonwoven fabric composed of a thermoplastic polymer fiber of the first aerosol blocking layer 220.

More specifically, the nonwoven fabric of the first aerosol blocking layer 220 may have a basis weight of 34 to 40 g/m², and the second aerosol blocking layer 260 may be a nonwoven fabric having a basis weight of 17 to 32 g/m². Most specifically, the nonwoven fabric of the first aerosol blocking layer 220 may have a basis weight of 34 to 35 g/m², and the second aerosol blocking layer 260 may be a nonwoven fabric having a basis weight of 24 to 25 g/m².

When the nonwoven fabric of the first aerosol blocking layer 220 has a basis weight of 34 to 35 g/m² and the second aerosol blocking layer 260 has a basis weight of 24 to 25 g/m², pore structure can be controlled finely to increase the adsorption rate and permeation resistance for a vapor-type chemical agent without direct control of the activated carbon fiber used in the adsorption layer 230 while improving the circulation of air, moisture, and heat. Accordingly, when used as a product for chemical, biological, and radiological protection, it can reduce the wearer's thermal fatigue and increase activity by blocking the inflow of penetrating fluids, and at the same time actively discharging heat and moisture emitted from the wearer's body to the outside.

The difference in the pore distribution of the nonwoven fabric of the first aerosol blocking layer 220 and the nonwoven fabric of the second aerosol blocking layer 260 can be expressed as follows: upon analysis by mercury porosimetry, the volume of pores with a diameter of 100 μm (dV/d (log D)) is specifically, 9-10 for the nonwoven fabric of the first aerosol blocking layer (basis weight: 35 g/m²), and 5-6 for the nonwoven fabric of the second aerosol blocking layer (weight: 25 g/m²).

The multilayer fabric for chemical, biological, radiological and explosive protection having the above-described configuration blocks pores of 10 μm to 30 μm among the pores of activated carbon fibers, but does not block pores of 50 μm or more which are important for air permeability. It reduces micropores smaller than 1 nm, while maintaining micropores of 1-2 nm and increasing micropores of 7-10 nm.

That is, by precisely controlling and regulating the pore distribution of the activated carbon fiber, especially the type of micropores, with the pore gradient structure (pressure gradient structure) of the first and second aerosol blocking layers 220, 260, the protective performance and thermal fatigue-related moisture permeability, air permeability, and water vapor resistance can be improved without weight increase of the multilayer fabric for chemical, biological, radiological, nuclear or explosive protection.

Specifically, the adhesive may be applied in dot form. The adhesive is not particularly limited as long as it can be fixed firmly to the second aerosol blocking layer 260. Specifically, it may be one or more selected from a group consisting of polyethylene (HDPE, LDPE), polyamide (PA), polyurethane (PU), and polyester (PES). More specifically, a polyamide adhesive having a glass transition temperature of 40° C. to 80° C. may be used.

In addition, the adhesive may be specifically applied in dot form on the surface of the second aerosol blocking layer 260, and it is preferable that the dot density is in the range of 20 to 180 dots/cm² and the application amount is in the range of 8 to 10 g/m².

If the dot density exceeds 180 dots/cm² or if the application amount exceeds 10 g/m², a problem may occur in which the adhesive coagulates to form a film. In this case, the air permeability of the fabric itself may be reduced, and residual adhesive may seep into the first aerosol blocking layer 260, reducing the overall flexibility and elasticity of the fabric.

And, if the dot density exceeds 20 dots/cm² or if the application amount is less than 8 g/m², the second aerosol blocking layer 260 may not be stably fixed to other layers. Therefore, it is desirable to satisfy the above-described condition.

When an adhesive is provided to satisfy the above-described condition, the adhesive can be firmly fixed to the other layers while minimizing the decrease in the specific surface area of the adsorption layer 260, thereby improving flexibility while maintaining the ventilation and protective functions of the fabric.

The multilayer fabric for chemical, biological, radiological and explosive protection according to a sixth exemplary embodiment of the present disclosure is different from the third to fifth exemplary embodiments described above in that it further includes a support fabric 270, as shown in FIG. 6. So, only the difference will be explained in the followings.

The support fabric 270 is arranged below the radiation shielding layer 250 or the second aerosol blocking layer 260. Specifically, the second aerosol blocking layer 260, the radiation shielding layer 250, the shock absorbing layer 240, the adsorption layer 230a, 230b, 230c, the first aerosol blocking layer 220, and the cover fabric 210 are sequentially attached to the upper part of the support fabric 270 to form an integrated fabric so as to block chemical agents from coming into contact with the skin at the front surface, while sweat or moisture is released to the outside, thereby providing a lightweight chemical, biological, radiological, and nuclear protective clothing having the excellent protective performance as described above.

Since it is possible to facilitate the wearer's activities by repeating the process of releasing heat or sweat by ensuring good ventilation through the support fabric 270, it can be used in various places. And, since the second aerosol blocking layer 260, the radiation shielding layer 250, the shock absorbing layer 240, the absorption layer 230a, 230b, 230c, and the first aerosol blocking layer 220 are protected stably, no additional maintenance cost is required.

The support fabric 270 is a part of the multilayer fabric for chemical, biological, radiological, nuclear or explosive protection that comes into contact with the wearer's skin. It is not particularly limited as long as it is a material used as a lining. Specifically, it may include a fabric prepared one or more material selected from a group consisting of polyester, nylon, polyamide, polyvinyl chloride, polyketone, polycarbonate, fluoropolymer, polyacrylate, polyurethane and polypropylene, or a mixed fabric thereof. Specifically, polyester and nylon may be used. The support fabric 270 may be selected in consideration of the required strength and overall weight level, and specifically may have a basis weight of 10 g/m² to 100 g/m².

The support fabric 270 may be a hydrophobic fiber substrate, and by forming a wettability gradient in consideration of the wettability of the nonwoven adsorption layer and the support fabric layer, heat and sweat generated within the body can be easily discharged to the outside.

According to the sixth exemplary embodiment described above, the wearer can be more safely protected from various chemical agents through the water-repellent and oil-repellent properties of the support fabric 270.

The multilayer fabric according to the first to sixth exemplary embodiments described above can be utilized as a clothing for the above-described purpose and, in addition, it may be prepared into a chemical, biological, and radiological protection clothing, a chemical, biological, and radiological gas mask, a canister, a combat uniform, a field tent, a camouflage net, a police uniform, and an industrial protective clothing, having protective performance and the effect of minimizing thermal fatigue. In this case, the multilayer fabric for chemical, biological, radiological, nuclear or explosive protection can be used as the outer fabric or shell of the chemical, biological, and radiological protection clothing, or alternatively, it can be used as the lining or inner fabric.

The multilayer fabric for chemical, biological, radiological, nuclear or explosive protection is used so that the cover fabric 100 is used as the surface exposed to the external environment.

In addition, since the prepared chemical, biological, and radiological protection clothing has improved durability and all-weather chemical, biological, and radiological protective performance due to the components described above, has excellent comfort of wearing, high durability and short wearing time, provides airtightness and excellent activity without weight increase, and has excellent air permeability and drying power as well as preventing penetration of sharp objects, the wearer can be protected from various threats.

Since the above-described exemplary embodiments are merely specific examples of the present disclosure, the scope of the present disclosure is not limited thereto, and appropriate modifications (changes in structure or constitution, partial omissions, or supplements) are possible within the scope of the same technical idea as long as the essential characteristics can be satisfied. Additionally, some or many of the features the above-described exemplary embodiments may be combined with each other.

Accordingly, the structure and constitution of each component shown in the exemplary embodiments of the present disclosure can be implemented with modification or combination, and therefore, it is evident that modifications or combinations of such structure and constitution fall within the scope of the appended claims of the present disclosure.

### <Preparation Example 1> Preparation of Deep Eutectic Solvent

A deep eutectic solvent (DES) was prepared according to Reaction Scheme 1 by mixing choline chloride (ChCl) and glycerin at a molar ratio of 1:2 and heating in an oil bath at 80° C.

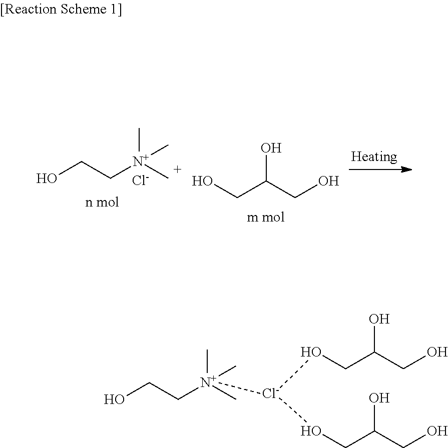

### <Preparation Example 2> Preparation of PVA Aqueous Solution

A PVA aqueous solution was prepared by adding 20 wt % of PVA to distilled water and dissolving in an oil bath at 95° C. for 24 hours.

### <Example 1> Preparation of Multilayer Fabric for Chemical, Biological, Radiological, Nuclear or Explosive Protection with Pressure Gradient Structure (Multilayer Pressure Gradient Structure)

A multilayer fabric for chemical, biological, radiological, nuclear or explosive protection was prepared as follows. An activated carbon fiber was prepared using rayon-based raw materials by stabilizing at 200 to 400° C., carbonizing at 600 to 800° C., and activating with steam for 10 to 40 minutes. The activated carbon fiber having a basis weight of 200 to 300 g/m² and a BET surface area of 2000 to 2500 m²/g was prepared using a knitting method. The activated carbon fiber had a ratio of micropores of 2 nm or smaller of 80% or higher and a pore size of 10 to 100 μm. Since it quickly adsorbs moisture or organic substances, it was dried at high temperature (80° C.), and then stored in sealed packaging before preparing and packaging into a protective clothing.

Next, in order to fix the activated carbon fiber to the first and second aerosol blocking layers, an adhesive was applied in dot form to one surface of the first and second aerosol blocking layers. The adhesive was a polyamide adhesive having a glass transition temperature of 40° C. to 80° C. The adhesive was applied to an amount of 8-10 g/cm² and a dot density of 100 dots/cm².

As the first and second aerosol blocking layers, mixed nonwoven fabrics of polyethylene terephthalate (PET) and nylon with different pore distributions were used. Specifically, the first aerosol blocking layer was a nonwoven fabric having a basis weight of 35 g/m² and a pore size of 20 μm to 1000 μm, prepared by mixing polyethylene terephthalate (PET) and nylon at a ratio of 50:50, and the second aerosol blocking layer was a nonwoven fabric having a basis weight of 25 g/m² and a pore size of 20 μm to 1000 μm, prepared by mixing polyethylene terephthalate (PET) and nylon at a ratio of 15:85.

Since the first and second aerosol blocking layers have different pore distributions, the multilayer fabric for chemical, biological, radiological, nuclear or explosive protection can have a pressure gradient structure that induces a pressure drop in the inflow direction and a pressure loss in the outflow direction.

The activated carbon fiber was positioned between the first and second aerosol blocking layers to which the adhesive was applied, and then adhesion was attempted. After melting the dot-shaped adhesive of the first and second aerosol blocking layers through a heating and pressurizing process with the temperature set to 110° C., the pressure to 2.0 bar, and the speed to 1 m/min to 5 m/min, an adsorption layer was attached.

### <Example 2> Preparation of Viscoelastomer with Multipurpose Protective Function

The DES prepared in Preparation Example 1 and the PVA aqueous solution prepared in Preparation Example 2 were mixed. A DES-PVA mixture (viscoelastomer) was prepared by mixing with 100 parts by weight of DES based on 100 parts by weight of PVA, rather than the weight of the PVA aqueous solution. The mixture was mixed using a stirrer for 30 minutes, placed in a mold, and dried on a hot plate at 70° C. for 72 hours to prepare viscoelastomers in the form of a film or a plate of various thicknesses.

The viscoelastomer prepared in Example 2 was prepared into a specimen as follows for evaluation of characteristics:

\textcircled{1} a viscoelastomer in the form of a film having a thickness of 0.07 mm, a width of 1 cm and a length of 5 cm, or \textcircled{2} a viscoelastomer in the form of a hexahedron having a thickness of 5 mm, a width of 1 cm and a length of 1 cm.

### <Comparative Example 1> Multilayer Fabric for Chemical, Biological, Radiological, Nuclear or Explosive Protection without Pressure Gradient Structure (Multilayer Structure)

A multilayer fabric for chemical, biological, radiological, nuclear or explosive protection was prepared in the same manner as in Example 1, except that the nonwoven fabrics of both the first and second aerosol blocking layers had a basis weight of 25 g/m².

### <Test Example 1> Analysis of Pore Distribution

For the multilayer fabric for chemical, biological, radiological, nuclear or explosive protection of Example 1 including the nonwoven fabric of the first aerosol blocking layer used in the present disclosure (basis weight: 35 g/m²) and the nonwoven fabric of the second aerosol blocking layer (basis weight: 25 g/m²), and the multilayer fabric for chemical, biological, radiological, nuclear or explosive protection of Comparative Example 1, the pore size and size distribution of macropores present on the surface were measured by adsorbing Hg using a porosimeter (PM33GT, Quantachrome, USA). Specifically, the sample was sufficiently pretreated at 100° C. for 72 hours to completely remove any excess moisture in the sample, and then mercury was adsorbed by changing the pressure on the sample.

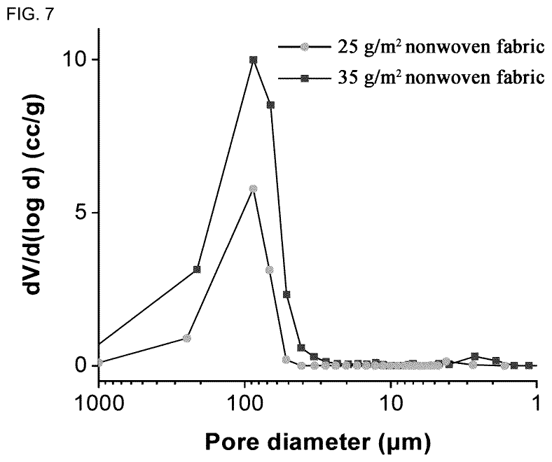

FIG. 7 shows a result of comparing the pore distribution of the nonwoven fabric of the first aerosol blocking layer (basis weight: 35 g/m²) with the nonwoven fabric of the second aerosol blocking layer (basis weight: 25 g/m²).

As shown in FIG. 7, the nonwoven fabric of the first aerosol blocking layer (basis weight: 35 g/m²) had more pores than the nonwoven fabric of the second aerosol blocking layer (basis weight: 25 g/m²). Specifically, the distribution of pores having a diameter of 100 μm was about 2 times higher for the nonwoven fabric of the first aerosol blocking layer (basis weight: 35 g/m²) than the nonwoven fabric of the second aerosol blocking layer (basis weight: 25 g/m²).

Specifically, the volume of pores with a diameter of 100 μm (dV/d (log D)) may be 9-10 for the nonwoven fabric of the first aerosol blocking layer (basis weight: 35 g/m²), and 5-6 for the nonwoven fabric of the second aerosol blocking layer (weight: 25 g/m²).

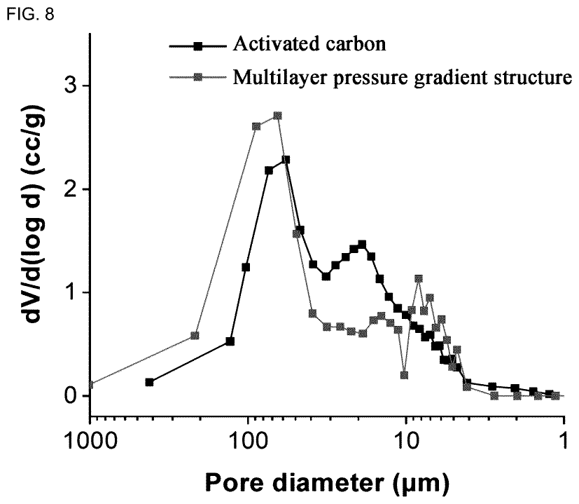

FIG. 8 shows a result of comparing the pore distribution of a multilayer fabric for chemical, biological, radiological, nuclear or explosive protection prepared in Example 1 with an activated carbon fiber. dV/d (log D) is log (differential pore volume), wherein dV represents the differential pore volume and d (log D) represents the differential value of log (pore diameter D).

As shown in FIG. 8, it was confirmed that the multilayer fabric for chemical, biological, radiological, nuclear or explosive protection prepared in Example 1 blocked pores of 10 μm to 30 μm among the pores of the activated carbon fiber but did not block pores of 50 μm or larger, which are important for air permeability. That is, it can be seen that the pore distribution of the activated carbon fiber can be controlled and adjusted finely with the pore gradient structure (pressure gradient structure) of the multilayer fabric for chemical, biological, radiological, nuclear or explosive protection prepared in Example 1.

### <Test Example 2> Analysis of Micropore Distribution

In order to confirm the micropore distribution of the multilayer fabric for chemical, biological, radiological, nuclear or explosive protection and activated carbon fiber prepared in Example 1, N₂ adsorption and DFT analysis were performed as follows.

The micropore volume and micropore distribution of the activated carbon fiber used in the present disclosure, the multilayer fabric for chemical, biological, radiological, nuclear or explosive protection of Example 1, and the multilayer fabric for chemical, biological, radiological, nuclear or explosive protection of Comparative Example 1 were analyzed using a surface area and pore size analyzer (Autosorb-iQ & Quadrasorb SI, Quantachrome, USA) using a DFT (density functional theory) model and the N₂ gas adsorption-desorption method. Specifically, the sample was pretreated sufficiently at 100° C. for 72 hours to completely remove excess moisture in the sample, and then nitrogen adsorption was performed at −196° C.

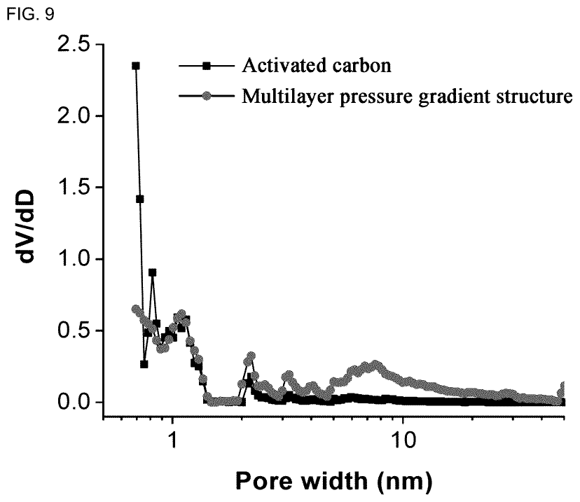

FIG. 9 shows the micropore distribution of the multilayer fabric for chemical, biological, radiological, nuclear or explosive protection prepared in Example 1 and the activated carbon fiber. It was confirmed that the multilayer fabric for chemical, biological, radiological, nuclear or explosive protection prepared in Example 1 has a pore gradient structure (pressure gradient structure) and maintains micropores of 1-2 nm in the activated carbon fiber, with reduced micropores smaller than 1 nm and increased micropores of 7-10 nm.

That is, it can be seen that the pore distribution of the activated carbon fiber, especially the type of micropores, is finely controlled and adjusted by the pore gradient structure (pressure gradient structure) of the multilayer fabric for chemical, biological, radiological, nuclear or explosive protection prepared in Example 1.

### <Test Example 3> Evaluation of Protective Performance

### Analysis of Adsorption Rate of Chemical Agent Simulant for Multilayer Fabric for Chemical, Biological, Radiological, Nuclear or Explosive Protection

A chemical agent simulant vapor was used to verify chemical agent blocking performance. The chemical agent simulant generally refers to a low-toxicity compound with a chemical structure similar to that of an actual agent. For example, blister agent simulants include methyl salicylate and 2-chloroethyl ethyl sulfide. In this example, 2-chloroethyl ethyl sulfide was used instead of the blistering agent sulfur mustard.

The liquid chemical agent simulant was first placed in a beaker heated to 40° C., and the beaker inlet was sealed, so that a chemical agent simulant vapor was filled in the beaker.

To analyze the adsorption rate of the chemical agent simulant for the multilayer fabric for chemical, biological, radiological, nuclear or explosive protection, the adsorbent (activated carbon fiber (ACC5092-20) from KURAREI) whose initial weight was measured was placed in a 1-mL vial, and the multilayer fabric for chemical, biological, radiological, nuclear or explosive protection (sample) was placed at the entrance of the vial and then fixed with a vial cap having holes.

The vial with the multilayer fabric for chemical, biological, radiological, nuclear or explosive protection fixed was placed in the beaker filled with the prepared chemical agent simulant vapor and kept at 40° C. for 24 hours. After 24 hours, the vial with the multilayer fabric for chemical, biological, radiological, nuclear or explosive protection fixed was recovered, and the weight of the adsorbent that had adsorbed the chemical agent simulant that had passed through the multilayer fabric for chemical, biological, radiological, nuclear or explosive protection was measured again to evaluate the chemical agent adsorption and removal performance. The change in weight was converted into g/m²/day by dividing by the area penetrated by the chemical agent simulant and time.

The same activated carbon fiber used in the adsorption layer of Example 1 was used alone as a comparison group (activated carbon fiber). In addition, the multilayer fabric for chemical, biological, radiological, nuclear or explosive protection of Comparative Example 1 was used as a ‘multilayer structure’ comparison group.

### Analysis Results

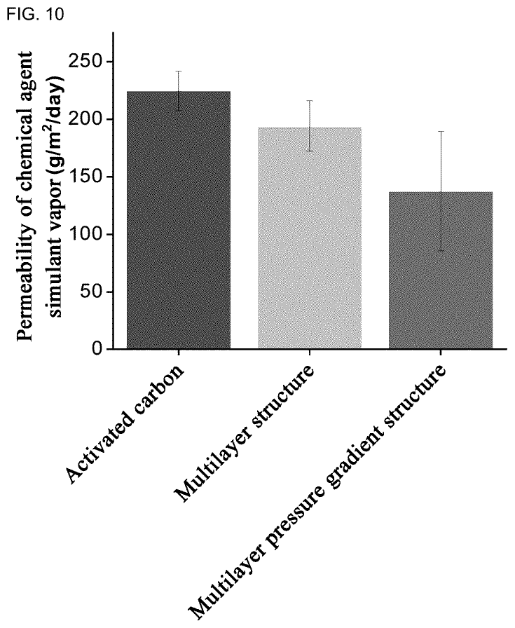

FIG. 10 shows a result of analyzing the chemical agent simulant permeability of the activated carbon fiber, the multilayer fabric for chemical, biological, radiological, nuclear or explosive protection prepared in Example 1 (multilayer pressure gradient structure), and the multilayer fabric for chemical, biological, radiological, nuclear or explosive protection prepared in Comparative Example 1 (multilayer structure).

As shown in FIG. 10, it was confirmed that the activated carbon fiber showed a chemical agent simulant permeability of 224±17 g/m²/day, the multilayer fabric for chemical, biological, radiological, nuclear or explosive protection prepared in Example 1 showed a chemical agent simulant permeability of 137±52 g/m²/day, and the multilayer fabric for chemical, biological, radiological, nuclear or explosive protection prepared in Comparative Example 1 showed a chemical agent simulant permeability of 193±22 g/m²/day. That is, by finely controlling and regulating the pore distribution, especially the type of micropores, of the activated carbon fiber with the pore gradient structure (pressure gradient structure) of the multilayer fabric for chemical, biological, radiological, nuclear or explosive protection prepared in Example 1, the penetration of the chemical agent simulant was reduced by 30% only by structurally adjusting the pore distribution of the first and second aerosol blocking layers with different pore distribution without weight increase.

The pore gradient structure (multilayer pressure gradient structure) of the multilayer fabric for chemical, biological, radiological, nuclear or explosive protection prepared in Example 1 effectively blocked the inflow of the chemical agent simulant vapor by strengthening the pressure applied to the inflow of the vapor.

### <Test Example 4> Evaluation of Air Permeability, Water Permeability, and Water Vapor Resistance

### Measurement of Air Permeability

The multilayer fabric for chemical, biological, radiological, nuclear or explosive protection prepared in Example 1 and the multilayer fabric for chemical, biological, radiological, nuclear or explosive protection prepared in Comparative Example 1 were used as samples for comparative analysis. Each sample was prepared to 20 cm² and evaluated. Measurement was made by the Korea Apparel Testing & Research institute according to the KS K ISO 9237 standard. Specifically, after fixing the sample to an air permeability meter (FX-3300, Textest, Swiss), the air flow rate at which the pressure difference across the test sample in the vertical direction became 100 Pa was measured, and the amount of air flow was converted to ft³/ft²/min. The air permeability was calculated using the following equation.

$$R = \frac{\overline{{q}_{V}}}{A} \times 167 \qquad [ Equation 1 ]$$

q̅ᵥ̅: arithmetic mean of flow rate (dm³/min)

A: test area of sample (cm²)

167: constant for converting to dm³/min/cm²

### Measurement of Water Permeability

The multilayer fabric for chemical, biological, radiological, nuclear or explosive protection prepared in Example 1 and the multilayer fabric for chemical, biological, radiological, nuclear or explosive protection prepared in Comparative Example 1 were used as samples for comparative analysis. Each sample was prepared to 1 cm². The sample was placed at the entrance of a 1-mL vial containing water and then fixed with a vial cap having holes. After measuring initial weight, the sample was placed in a beaker at 40° C. and the beaker opening was sealed. After letting alone for 24 hours, the weight of the sample was measured. The weight change of the sample was divided by the area through which moisture penetrated and time, and converted to g/m²/day.

### Measurement of Water Vapor Resistance

Water vapor resistance refers to the amount of heat required for water vapor to pass through the sample and is related to thermal fatigue. Water vapor resistance measurement was analyzed by the Korea Apparel Testing & Research institute according to the ISO 11092 standard. Specifically, a multilayer fabric for chemical, biological, radiological, nuclear or explosive protection prepared in Example 1 and a multilayer fabric for chemical, biological, radiological, nuclear or explosive protection prepared in Comparative Example 1 were used as samples for comparative analysis. Each sample was prepared to 1 m². The water vapor pressure (pa) and saturated water vapor pressure (pₘ) on the surface of the measurement section were measured inside a measurement room under the condition of 35° C. and 40% R.H. Water vapor resistance (m²·Pa/W) was calculated from the following equation.

$${R}_{et} = \frac{( {p}_{m} - {p}_{a} ) * A}{H - Δ {H}_{e}} - {R}_{et 0} \qquad [ Equation 2 ]$$

Rₑₜ₀: constant related to the moisture resistance measuring equipment (m²·K/W)

A: area of the measuring section (m²)

H: heating power supplied to the measuring section (W)

ΔHₑ: heating power correction value during measurement of moisture permeability (Rₑₜ)

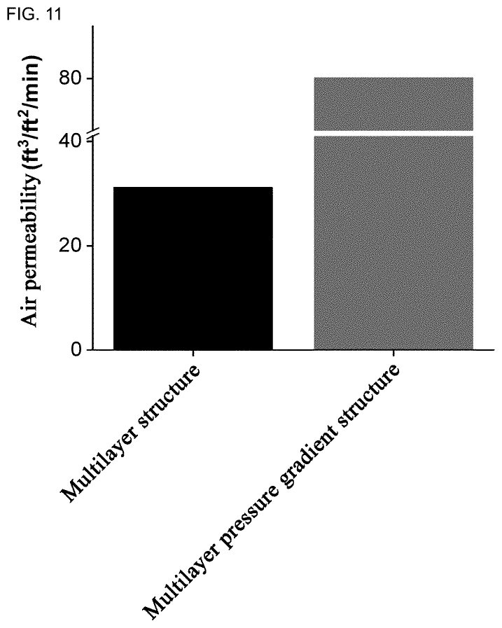

FIG. 11 shows a result of analyzing the air permeability of a multilayer fabric for chemical, biological, radiological, nuclear or explosive protection prepared in Example 1 and a multilayer fabric for chemical, biological, radiological, nuclear or explosive protection prepared in Comparative Example 1.

As shown in FIG. 11, it was confirmed that the multilayer fabric for chemical, biological, radiological, nuclear or explosive protection prepared in Example 1 had an air permeability of 80.35 ft³/ft²/min, and the multilayer fabric for chemical, biological, radiological, nuclear or explosive protection prepared in Comparative Example 1 had an air permeability of 31.37 ft³/ft²/min.

That is, by precisely controlling and regulating the pore distribution, especially the type of micropores, of the activated carbon fiber with the pore gradient structure (pressure gradient structure) of the multilayer fabric for chemical, biological, radiological, nuclear or explosive protection prepared in Example 1, the air permeability was increased by 2.56 times as compared to Comparative Example 1 only by structurally adjusting the pore distribution of the first and second aerosol blocking layers with different pore distributions without weight increase.

It means that air circulation is smoother for the multilayer fabric for chemical, biological, radiological, nuclear or explosive protection prepared in Example 1 than that of the multilayer fabric for chemical, biological, radiological, nuclear or explosive protection of Comparative Example 1. Therefore, it can be confirmed that the multilayer fabric for chemical, biological, radiological, nuclear or explosive protection prepared in Example 1 has superior protective performance against chemical agents than that of Comparative Example 1, while reducing thermal fatigue due to air circulation, resulting in superior wearability and activity.

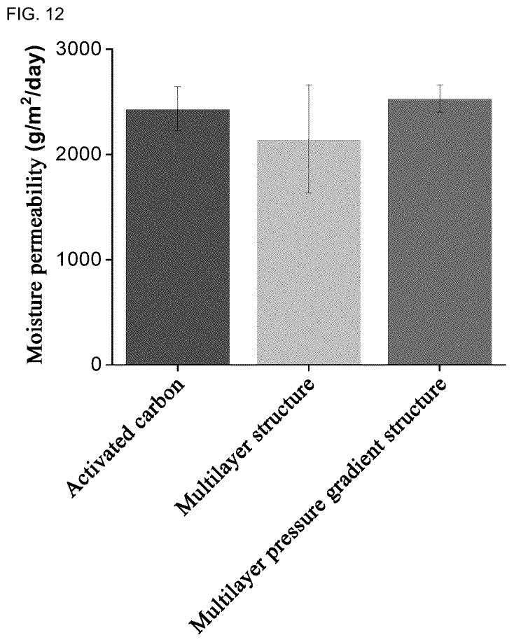

FIG. 12 shows a result of analyzing the moisture permeability of a multilayer fabric for chemical, biological, radiological, nuclear or explosive protection prepared in Example 1, a multilayer fabric for chemical, biological, radiological, nuclear or explosive protection prepared in Comparative Example 1, and an activated carbon fiber.

As shown in FIG. 12, the multilayer fabric for chemical, biological, radiological, nuclear or explosive protection prepared in Example 1 had a moisture permeability of 2532±131 g/m²/day, the multilayer fabric for chemical, biological, radiological, nuclear or explosive protection prepared in Comparative Example 1 had a moisture permeability of 2147±515 g/m²/day, and the moisture permeability of the activated carbon fiber was confirmed to be 2433±210 g/m²/day.

That is, by precisely controlling and regulating the pore distribution, especially the type of micropores, of the activated carbon fiber with the pore gradient structure (pressure gradient structure) of the multilayer fabric for chemical, biological, radiological, nuclear or explosive protection prepared in Example 1, the moisture permeability could be increased as compared to Comparative Example 1 only by structurally adjusting the pore distribution of the first and second aerosol blocking layers with different pore distributions without weight increase.

Specifically, the multilayer fabric for chemical, biological, radiological, nuclear or explosive protection prepared in Example 1 has a pressure gradient structure formed by the pore gradient structure, which causes a pressure loss in the flow of moisture flowing out, thereby promoting permeation.

Therefore, it can be confirmed that the multilayer fabric for chemical, biological, radiological, nuclear or explosive protection prepared in Example 1 has superior protective performance against chemical agents than that of Comparative Example 1, while releasing moisture smoothly as well as circulating air smoothly, thereby reducing thermal fatigue and providing superior wearability and activity.

Accordingly, it can be seen that the multilayer fabric for chemical, biological, radiological, nuclear or explosive protection according to the present disclosure not only has excellent protective performance, but also allows heat and sweat to be discharged to the outside during the wearer's activities, thereby reducing thermal fatigue and providing higher protective performance, comfort, and activities than the conventional chemical, biological, and radiological protection fabric.

### <Test Example 5> Analysis of Crystal Size of Viscoelastomer

The crystal size of the PVA aqueous solution prepared in Preparation Example 2 (before addition of DES) and the viscoelastomer prepared in Example 2 (after addition of DES) was analyzed by X-ray diffraction analysis.

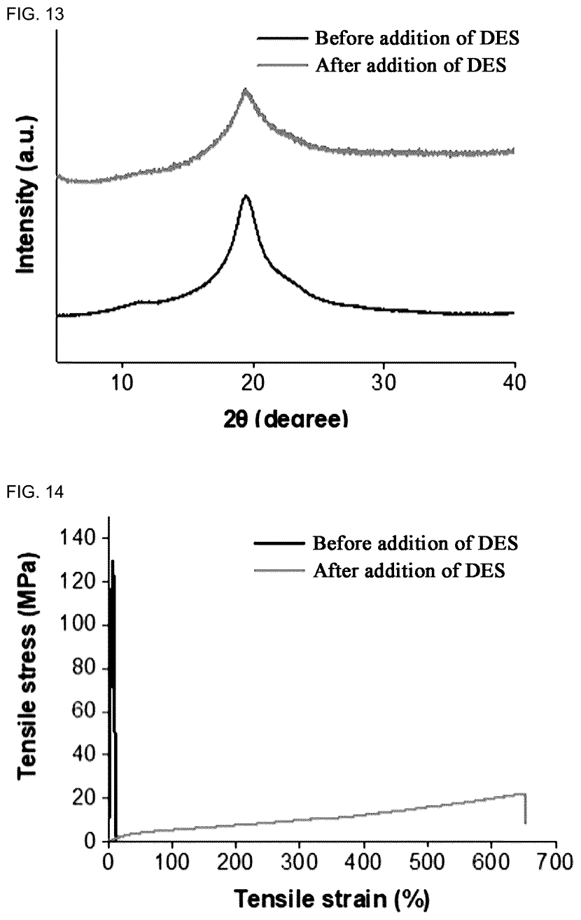

FIG. 13 shows the X-ray diffraction (XRD) spectra of the PVA aqueous solution prepared in Preparation Example 2 (before addition of DES) and the viscoelastomer prepared in Example 2 (after addition of DES). The crystal size was calculated according to the following Equation 3 using crystal peaks.

$${D}_{p} = \frac{0.94 \times λ}{β \times cos θ} \qquad [ Equation 3 ]$$

In Equation 3, Dₚ is the average crystal size, λ is the X-ray wavelength, β is the half-width in radians, and θ is the Bragg angle.

As seen from FIG. 13, the crystal size of the PVA aqueous solution prepared in Preparation Example 2 (before addition of DES) and the viscoelastomer prepared in Example 2 (after addition of DES) was confirmed to be 3.09 nm and 2.03 nm, respectively. That is, it can be seen that the viscoelastomer of Example 2 according to the present disclosure has a significantly decreased crystal size as compared to the PVA aqueous solution. That is, since DES interferes with hydrogen bonding between PVA, it can be seen that the amorphousness of PVA increases due to entanglement of polymer chains as the crystal size within the viscoelastomer decreases.

### <Test Example 6> Analysis of Tensile Strength of Viscoelastomer

The tensile strength (kgf/inch) of the PVA aqueous solution prepared in Preparation Example 2 (before addition of DES) and the viscoelastomer prepared in Example 2 (after addition of DES) were measured according to the American Society for Testing and Materials standard ASTM D 5034. Specifically, the fabric was cut to prepare a specimen. The specimen was fixed to the lower clamp of the measuring device, and the upper clamp was moved upward to measure the strength and elongation at break of the specimen, respectively.

FIG. 14 shows a result of measuring the tensile strength of a PVA aqueous solution prepared in Preparation Example 2 (before addition of DES) and a viscoelastomer prepared in Example 2 (after addition of DES).

As shown in FIG. 14, the viscoelastomer prepared in Example 2 (after addition of DES) showed an increase in amorphousness, resulting in increase in tensile strain by 8,386% and increase in toughness by 202%.

### <Test Example 7> Adsorption of Chemical Agent Simulant and Evaluation of Shock Absorbing Function

A chemical agent simulant vapor was used to confirm the change in the physical properties of the viscoelastomer prepared in Example 2 (after addition of DES) due to adsorption of the chemical agent. The chemical agent simulant generally refers to a low-toxicity compound with a chemical structure similar to that of an actual agent. For example, blister agent simulants include methyl salicylate and 2-chloroethyl ethyl sulfide. In this example, methyl salicylate (MeS) vapor was used as a blister agent simulant instead of a blistering agent.

The liquid chemical agent simulant was first placed in a beaker heated to 40° C., and the beaker inlet was sealed, so that a chemical agent simulant vapor was filled in the beaker.

In order to analyze the adsorption rate of the chemical agent simulant of the viscoelastomer according to the present disclosure, the viscoelastomer (sample) whose initial weight was measured was placed at the entrance of a 1-ml vial and then fixed with a vial cap having holes.

The vial with the viscoelastomer fixed was placed in the beaker filled with the prepared chemical agent simulant vapor and kept at 40° C. for 1 hour, while measuring Raman spectra at 10-minute intervals to confirm the change in the network and mechanical properties.

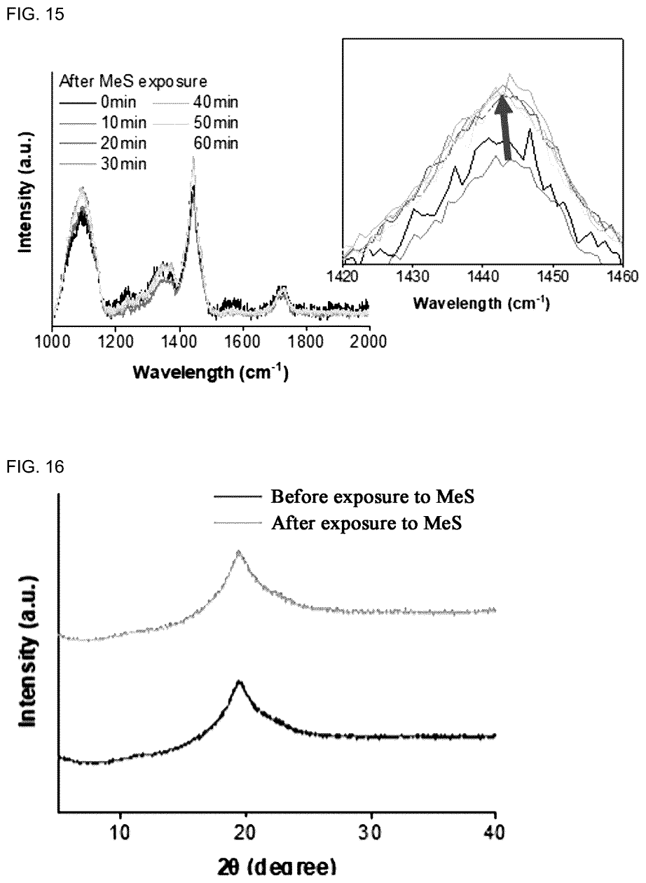

FIG. 15 shows the Raman spectra obtained to confirm the bonding between polymer chains in the viscoelastomer prepared in Example 2 (after addition of DES) after treating with the chemical agent simulant (MeS).

As shown in FIG. 15, the analysis result of the viscoelastomer prepared in Example 2 (after addition of DES) showed a hydrogen bonding-related peak in the PVA polymer chain between 1440 cm⁻¹ and 1450 cm⁻¹, and it was confirmed that the hydrogen bonding-related peak shifted to a lower wavelength after exposure to the chemical agent simulant.

The peak shift of the viscoelastomer prepared in Example 2 (after addition of DES) upon exposure to the chemical agent simulant indicates that hydrogen bonds were formed between the polymer chains of the viscoelastomer by the hydrophobic chemical agent simulant.

The crystal size of the viscoelastomer prepared in Example 2 was analyzed by X-ray diffraction analysis before and after treatment with the chemical agent simulant (MeS) for 60 minutes.

FIG. 16 shows the X-ray diffraction (XRD) spectra of the viscoelastomer prepared in Example 2 before and after treatment with the chemical agent simulant (MeS) for 60 minutes. Crystal size was calculated according to Equation 1 using the crystal peak.

As shown in FIG. 16, it was confirmed that the chemical agent simulant (MeS) did not affect the crystal size of the viscoelastomer prepared in Example 2. That is, it can be seen that the formation of hydrogen bonds between the polymer chains of the viscoelastomer induced by the chemical agent simulant (MeS) does not affect the crystal size of the viscoelastomer.

### <Test Example 8> Analysis of Viscoelastic Coefficient and Loss Factor of Viscoelastomer

A chemical agent simulant vapor was used to verify the chemical agent blocking performance of the viscoelastomer prepared in Example 2 (after addition of DES). The chemical agent simulant generally refers to a low-toxicity compound with a chemical structure similar to that of an actual agent. For example, blister agent simulants include methyl salicylate and 2-chloroethyl ethyl sulfide. In this example, methyl salicylate (MeS) vapor was used as a blister agent simulant instead of a blistering agent.

The liquid chemical agent simulant was first placed in a beaker heated to 40° C., and the beaker inlet was sealed, so that a chemical agent simulant vapor was filled in the beaker.

Viscoelastic coefficient and shear stress were measured to investigate the effect of adsorption of the chemical agent simulant on the polymer chain of the viscoelastic agent.

The viscoelastomer was placed in a vial (a container smaller than the beaker containing the simulant vapor) so that it did not come into direct contact with the liquid chemical agent simulant inside a beaker filled with the previously prepared chemical agent simulant vapor, and kept at 40° C. for 1 hour. The viscoelastomer was recovered every 10 minutes and viscoelastic coefficient (G′, G″), shear stress, and stress were measured using a rheometer (MCR 302, Anton Paar, Austria), the Rheocompass software (Anton Paar), and a plate-shaped accessory with a diameter of 8 mm. The stress was measured by stretching a 0.07-mm long viscoelastomer sample by 25%. Viscoelastomer samples of 4 to 6 mm were used in other experiments.

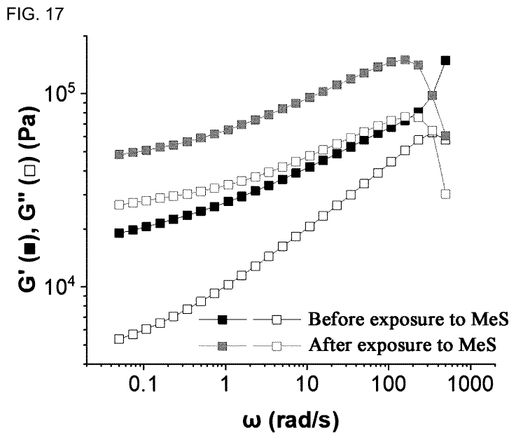

FIG. 17 shows the result of measuring the viscoelastic coefficient (G′, G″) of the viscoelastomer prepared in Example 2 before and after treatment with a chemical agent simulant (MeS) for 60 minutes. It was confirmed that the viscoelastic coefficient (G′, G″) of the viscoelastomer prepared in Example 1 before exposure to the chemical agent simulant did not have an intersection point at various rad/s. That is, it was confirmed that the viscoelastomer prepared in Example 2 can withstand impacts of various rad/s.

It was confirmed that the hydrogen bonds formed within the viscoelastomer prepared in Example 2 after exposure to the chemical agent simulant increased the viscoelastic coefficient (G′, G″). This indicates that the polymer packing density increases due to the enhancement of hydrogen bonding between the polymer chains of the viscoelastomer exposed to the chemical agent simulant, resulting in increased durability against the chemical agent.

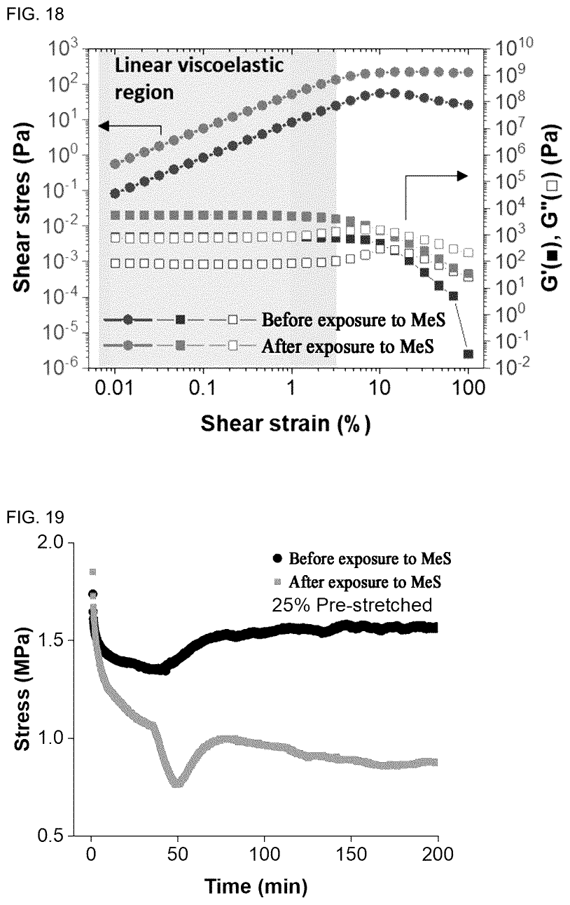

FIG. 18 shows a result of measuring the shear stress of a viscoelastomer prepared in Example 2 before and after treatment with a chemical agent simulant (MeS) for 60 minutes.

From the shear stress shown in FIG. 18, it can be confirmed whether the viscoelastomer prepared in Example 2 absorbs impact energy. The shear stress of the viscoelastomer prepared in Example 2 before exposure to the chemical agent simulant increased exponentially to 55 Pa. After exposure to the chemical agent simulant, the viscoelastomer prepared in Example 2 exhibited a rapid increase in shear stress up to 208 Pa.

Looking at the linear relationship between the storage coefficient and the loss factor on the right side of FIG. 18, it was confirmed that the viscoelastomer of Example 2 before chemical agent simulant treatment showed change from 0.01% to about 4%, and the viscoelastomer of Example 2 after chemical agent simulant treatment showed change from 0.01% to 1%. That is, it can be seen that the viscoelastomer of Example 2 has the properties of an elastic body that is deformed by impact before treatment with a chemical agent, but after treatment with a chemical agent, its properties change to those of a viscoelastomer that can minimize the deformation caused by the applied impact.

The change in the properties of the viscoelastomer of Example 2 described above is due to the shear stiffening effect caused by hydrogen bonding and increased polymer packing. Since the viscoelastomer of the present disclosure shows decreased linear relationship between shear strain and shear stress upon the adsorption of the chemical agent, it exhibits the shock-absorbing effect upon the adsorption of the chemical agent.

Through the above results, it was confirmed that the viscoelastomer prepared in Example 2 has a shock mitigation mechanism through impact energy dissipation before exposure to the chemical agent simulant, but mitigates the shock through impact energy absorption and impact energy dissipation for dissociation of hydrogen bonding after exposure to the chemical agent simulant.

FIG. 19 shows the result of measuring the stress of the viscoelastomer prepared in Example 2 before and after treatment with the chemical agent simulant (MeS) for 60 minutes.

As shown in FIG. 19, it was confirmed that the viscoelastomer prepared in Example 2 dispersed impact energy like an elastic body before exposure to the chemical agent simulant, and then the entangled chains were aligned along a certain direction.

On the other hand, after exposure to the chemical agent, it was confirmed that the viscoelastomer prepared in Example 2 dispersed and absorbed the initial impact energy, and dissociated hydrogen bonds, and thus the freed entangled chains were aligned along a certain direction while dispersing the impact energy.

### <Test Example 9> LAOS Analysis

The viscoelastomer prepared in Example 2 was treated with a chemical agent simulant as in Test Example 7.

The viscoelastomer was placed in a vial without direct contact with a liquid chemical agent simulant in a beaker filled with the previously chemical agent simulant vapor prepared above, and kept at 40° C. for 1 hour. The rheological properties were identified by measuring the change in strain stress as a function of frequency under large-amplitude oscillatory shear (LAOS).

LAOS analysis was performed using a rheometer (MCR 302, Anton Paar, Austria) and the Rheocompass software (Anton Paar) to determine the energy absorbed by the viscoelastomer of Example 2 while varying strain from 0.1% to 50% at a fixed frequency of 1 rad/s.

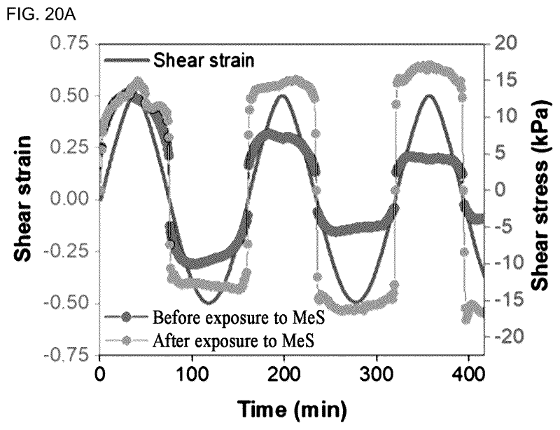

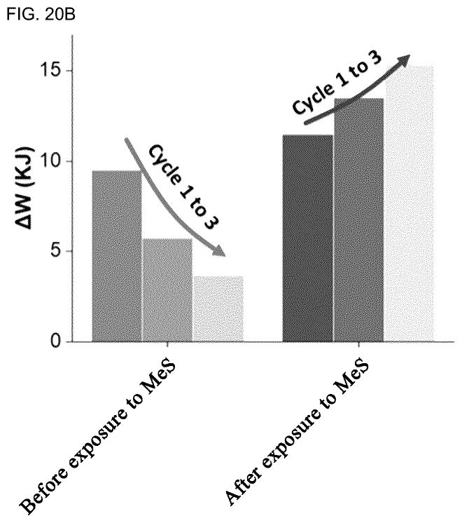

FIGS. 20A and 20B show the result of the LAOS (large-amplitude oscillatory shear) test for the viscoelastomer according to Example 2 before and after treatment with the chemical agent simulant (MeS). FIG. 20A shows shear stress over time, and FIG. 20B shows energy change over cycles.

As shown in FIGS. 20A and 20B, it was confirmed that the viscoelastomer of Example 2, before being treated with the chemical agent simulant, showed reduced impact energy that could be absorbed as the entangled amorphous polymer chains were released due to shear strain. After treatment with the chemical agent simulant, the viscoelastomer of Example 2 was found to be able to absorb 20% more energy than before MeS exposure.

After treatment with the chemical agent simulant, the viscoelastomer of Example 2 showed gradually increased energy absorption when the amplitude was increased repeatedly. That is, when the viscoelastomer according to the present disclosure is exposed to a chemical agent, it adsorbs the chemical agent, and thereby delays the dissociation of the entangled polymer chains through hydrogen bonds formed between the amorphous polymer chains, thereby increasing impact energy absorption efficiency.

As described above, it can be seen that the viscoelastomer prepared in Example 2 can effectively protect the wearer from explosion by dispersing or absorbing/dispersing impact energy both before and after exposure to a chemical agent, and at the same time, provides protection by adsorbing the chemical agent.

Accordingly, the viscoelastomer composed of i and ii according to the present disclosure, as prepared in the examples, is very useful because it is lightweight and has not only chemical, biological, and radiological protection performance but also a function of protecting the wearer from explosion.

Although the exemplary embodiments of the present disclosure have been described above, those skilled in the art will understand that the present disclosure can be implemented in other specific forms without changing the technical idea or essential features of the present disclosure.

Therefore, the exemplary embodiments described above are provided to fully inform a person having ordinary skill in the art of the present disclosure, and therefore, they should be understood to be exemplary and not restrictive in all respects, and the present disclosure is defined only by the scope of the claims.

[Description of Main Elements]

| | |
|---|---|
| 140, 210: | cover fabric |
| 110, 220: | first aerosol blocking layer |
| 120, 230: | adsorption layer |
| 230a, 230b, 230c: | adsorption layer with wrinkle structure |
| 240: | shock absorbing layer |
| 250: | radiation shielding layer |
| 130, 260: | second aerosol blocking layer |
| 150, 270: | support fabric |

We claim:

1. A multilayer fabric for chemical, biological, radiological, nuclear or explosive protection having a multilayer pressure gradient structure, comprising:
a first aerosol blocking layer made of a nonwoven fabric composed of a thermoplastic polymer fiber having aerosol particle blocking property;
an adsorption layer comprising an activated carbon fiber adsorbing an external chemical toxic substance attached to one surface of the first aerosol blocking layer; and
a second aerosol blocking layer made of a nonwoven fabric composed of a thermoplastic polymer fiber having aerosol particle blocking property, the second aerosol blocking layer being attached to the other surface of the adsorption layer and having a basis weight that is 0.5 to 0.8 times lower than that of the first aerosol blocking layer.

2. The multilayer fabric for chemical, biological, radiological, nuclear or explosive protection according to claim 1, wherein the first aerosol blocking layer is a nonwoven fabric prepared using one or more thermoplastic polymer fiber selected from a group consisting of polyurethane (PU), polypropylene (PP), polyester, polyethylene (PE), polyethylene terephthalate (PET), nylon (nylon 6), and viscose rayon.

3. The multilayer fabric for chemical, biological, radiological, nuclear or explosive protection according to claim 1, wherein the first aerosol blocking layer is a mixed nonwoven fabric prepared from polyethylene terephthalate (PET) and nylon (nylon 6).

4. The multilayer fabric for chemical, biological, radiological, nuclear or explosive protection according to claim 3, wherein
the first aerosol blocking layer is a nonwoven fabric wherein polyethylene terephthalate (PET) and nylon (nylon 6) are mixed at a weight ratio of 40:60 to 60:40, and
the second aerosol blocking layer is a nonwoven fabric wherein polyethylene terephthalate (PET) and nylon (nylon 6) are mixed at a weight ratio of 10:90 to 20:80.

5. The multilayer fabric for chemical, biological, radiological, nuclear or explosive protection according to claim 1, wherein the first aerosol blocking layer has a basis weight of 34 to 40 g/m².

6. The multilayer fabric for chemical, biological, radiological, nuclear or explosive protection according to claim 1, wherein the first aerosol blocking layer has a basis weight of 34 to 35 g/m², and the second aerosol blocking layer has a basis weight of 24 to 25 g/m².

7. The multilayer fabric for chemical, biological, radiological, nuclear or explosive protection according to claim 1, which further comprises a cover fabric prepared from a waterproof and heat-dissipating material on the outer surface of the first aerosol blocking layer.

8. The multilayer fabric for chemical, biological, radiological, nuclear or explosive protection according to claim 1, which further comprises a support fabric arranged on the outer surface of the second aerosol blocking layer.

9. The multilayer fabric for chemical, biological, radiological, nuclear or explosive protection according to claim 1, wherein
the first aerosol blocking layer is a nonwoven fabric having a basis weight of 34 to 35 g/m² wherein polyethylene terephthalate (PET) and nylon (nylon 6) are mixed at a weight ratio of 40:60 to 60:40,
the second aerosol blocking layer is a nonwoven fabric having a basis weight of 24 to 25 g/m² wherein polyethylene terephthalate (PET) and nylon (nylon 6) are mixed at a weight ratio of 10:90 to 20:80,
the nonwoven fabric of the first aerosol blocking layer has a pore distribution with a pore volume having a diameter of 100 μm (dV/d (log D)) of 9-10 when the macropore is analyzed by mercury porosimetery,
the nonwoven fabric of the second aerosol blocking layer has a pore distribution with a pore volume having a diameter of 100 μm (dV/d (log D)) of 5-6 when the macropore is analyzed by mercury porosimetery,
an adhesive is applied in dot form on the surface of the first aerosol blocking layer that comes into contact with the adsorption layer, and
the adhesive is a thermoplastic polyamide adhesive with a glass transition temperature of 40° C. to 80° C. and is applied on one surface in dot form with an amount of 8 to 10 g/m² to a dot density of 20 to 180 dots/cm².

10. A multilayer fabric for chemical, biological, radiological, nuclear or explosive protection, comprising:
a first aerosol blocking layer comprising a fabric, a knitted fabric or a nonwoven fabric made from any one of thermoplastic polymers having aerosol particle blocking property;
an adsorption layer provided with an activated carbon fiber that adsorbs external chemical toxic substances and is disposed below the first aerosol blocking layer;
a shock-absorbing layer disposed under the adsorption layer and comprising a viscoelastomer having the function of absorbing and dispersing shock; and
a radiation shielding layer comprising tungsten or boron nanoparticles, arranged under the shock-absorbing layer.

11. The multilayer fabric for chemical, biological, radiological, nuclear or explosive protection according to claim 10, wherein the thermoplastic polymer is one or more selected from a group consisting of polyurethane (PU), polypropylene (PP), polyester, polyethylene (PE), polyethylene terephthalate (PET), nylon (nylon 6), and viscose rayon.

12. The multilayer fabric for chemical, biological, radiological, nuclear or explosive protection according to claim 10, wherein the first aerosol blocking layer is a mixed nonwoven fabric prepared from polyethylene terephthalate (PET) and nylon (nylon 6).

13. The multilayer fabric for chemical, biological, radiological, nuclear or explosive protection according to claim 10, wherein an adhesive is applied in dot form on the surface of the first aerosol blocking layer that comes into contact with the adsorption layer.

14. The multilayer fabric for chemical, biological, radiological, nuclear or explosive protection according to claim 10, wherein the activated carbon fiber of the adsorption layer has a basis weight of 200 g/m² to 300 g/m² and a specific surface area of 2000 g/m² to 20,000 g/m², and comprises 70% to 90% of micropores with a size of 0.2 nm to 2 nm based on the total pore volume.

15. The multilayer fabric for chemical, biological, radiological, nuclear or explosive protection according to claim 10, wherein the viscoelastomer is one or more selected from a group consisting of polytetrafluoroethylene (PTFE), low-density polyethylene (LDPE), polyvinyl alcohol (PVA), polyvinyl chloride (PVC) and polyurethane (PU).

16. The multilayer fabric for chemical, biological, radiological, nuclear or explosive protection according to claim 10, wherein the viscoelastomer comprises i. a hydrophilic polymer having a functional group capable of hydrogen bonding; and ii. a deep eutectic solvent, wherein the mixing weight ratio of the hydrophilic polymer having a functional group capable of hydrogen bonding and the eutectic solvent is 0.5:1 to 1.5:1.

17. The multilayer fabric for chemical, biological, radiological, nuclear or explosive protection according to claim 16, wherein the deep eutectic solvent is a mixture of choline chloride and glycerin at a molar ratio of 1:1.5 to 1:2.5.

18. The multilayer fabric for chemical, biological, radiological, nuclear or explosive protection according to claim 10, wherein
the activated carbon fiber of the adsorption layer is arranged in a continuous wrinkle structure ranging from a flat form to a wave form, and
the wrinkle structure is a wrinkle structure having a round curve, a wrinkle structure having a square-shaped block, or an inclined wrinkle structure.

19. The multilayer fabric for chemical, biological, radiological, nuclear or explosive protection according to claim 18, wherein the inclined wrinkle structure of the adsorption layer is an inclined wrinkle structure having an angle of 30-50° toward the line of sight in an opposing position.

20. The multilayer fabric for chemical, biological, radiological, nuclear or explosive protection according to claim 10, which further comprises a second aerosol blocking layer made of a nonwoven fabric consisting of a thermoplastic polymer fiber having aerosol particle blocking property, the second aerosol blocking layer being disposed below the radiation shielding layer and having a basis weight 0.5 to 0.8 times lower than that of the first aerosol blocking layer.

21. The multilayer fabric for chemical, biological, radiological, nuclear or explosive protection according to claim 20, wherein the nonwoven fabric of the first aerosol blocking layer has a basis weight of 34 to 40 g/m², and the second aerosol blocking layer has a basis weight of 17 to 32 g/m².

22. The multilayer fabric for chemical, biological, radiological, nuclear or explosive protection according to claim 10, which further comprises:
a cover fabric coated with a water-repellent and oil-repellent agent placed on top of the first aerosol blocking layer; and
a support fabric arranged under the radiation shielding layer.

23. A clothing for chemical, biological, radiological, nuclear or explosive protection prepared from the multilayer fabric according to claim 1.

24. A clothing for chemical, biological, radiological, nuclear or explosive protection prepared from the multilayer fabric according to claim 10.
